(19) United States
(12) Patent Application Publication
(10) Pub. No.: US 2014/0062675 A1
(43) Pub. Date: Mar. 6, 2014

(54) DATA PROCESSING APPARATUS AND DEVICE COOPERATION METHOD

(71) Applicants: Yumiko MURATA, Tokyo (JP); Akira Masuda, Tokyo (JP); Takeshi Fujita, Tokyo (JP); Yasuharu Yanamura, Kanagawa (JP); Yohei Fujita, Kanagawa (JP); Tetsuro Kutsuwada, Kanagawa (JP); Kohichi Nishide, Tokyo (JP); Michiko Fujii, Tokyo (JP); Jun Murata, Tokyo (JP)

(72) Inventors: Yumiko MURATA, Tokyo (JP); Akira Masuda, Tokyo (JP); Takeshi Fujita, Tokyo (JP); Yasuharu Yanamura, Kanagawa (JP); Yohei Fujita, Kanagawa (JP); Tetsuro Kutsuwada, Kanagawa (JP); Kohichi Nishide, Tokyo (JP); Michiko Fujii, Tokyo (JP); Jun Murata, Tokyo (JP)

(73) Assignee: RICOH COMPANY, LTD., Tokyo (JP)

(21) Appl. No.: 13/962,001

(22) Filed: Aug. 8, 2013

(30) Foreign Application Priority Data
Aug. 31, 2012 (JP) 2012-192669

(51) Int. Cl. G08C 17/02

(52) U.S. Cl. CPC G08C 17/02
USPC 340/12.5

(57) ABSTRACT

A data processing apparatus includes a motion determining unit and a data processing unit. The motion determining unit detects a predetermined motion of a mobile terminal. The data processing unit selects a device to perform a device cooperation process with and to communicate with the mobile terminal based on a predetermined sound output by one or more devices, which are positioned nearby the mobile terminal, when the motion determining unit detects the predetermined motion of the mobile terminal. The predetermined sound are different for each of the devices.

### BACKGROUND OF THE INVENTION

1. Field of the Invention

The present invention relates to a data processing apparatus and a device cooperation method.

2. Description of the Related Art

Conventionally, when operating an external device by a mobile terminal such as a smartphone, a Personal Digital Assistant (PDA) or the like, for example, a method is known in which the mobile terminal and the external device are connected via a network to form device cooperation. Then, an instruction to operate the external device is input via an operation screen displayed on the mobile terminal (see Patent Document 1, for example).

Further, a method is known in which a shock wave pattern is generated by physical contact with a nearby target device to be connected and the device commonly owing the shockwave pattern is found on a network to form device cooperation (see Patent Document 2, for example).

Thus, according to the described mobile terminal 10, it is unnecessary for the user to operate the external device in accordance with a previously set operating method while seeing the operation screen of the user's mobile terminal. Further, for a method of finding a device via a network by generating a shock wave pattern as described above, devices which are positioned far from the mobile terminal are detected via the network. Thus, this technique is not suitable for a case when the mobile terminal is to be connected with a nearby terminal.

### PATENT DOCUMENTS

[Patent Document 1] Japanese Laid-open Patent Publication No. 2006-163794
[Patent Document 2] Japanese Patent No. 4074998

### SUMMARY OF THE INVENTION

The present invention is made in light of the above problems, and provides a data processing apparatus and a device cooperation method capable of being easily connected to an external device to perform a device cooperation process by a simple operation.

According to an embodiment, there is provided a data processing apparatus including a motion determining unit that detects a predetermined motion of a mobile terminal; and a data processing unit that selects a device to perform a device cooperation process with and to communicate with the mobile terminal based on a predetermined sound output by one or more devices, which are positioned nearby the mobile terminal, when the motion determining unit detects the predetermined motion of the mobile terminal, the predetermined sound being different for each of the devices.

According to another embodiment, there is provided a device cooperation method performed by a data processing apparatus including a motion detection step of detecting a predetermined motion of a mobile terminal; and a device selection step of selecting a device to perform a device cooperation process with and to communicate with the mobile terminal based on a predetermined sound output by one or more devices, which are positioned nearby the mobile terminal, when the predetermined motion of the mobile terminal is detected in the motion detection step, the predetermined sound being different for each of the devices.

Note that also arbitrary combinations of the above-described elements, and any changes of expressions in the present invention, made among methods, devices, systems, recording media, computer programs and so forth, are valid as embodiments of the present invention.

### BRIEF DESCRIPTION OF THE DRAWINGS

Other objects, features and advantages of the present invention will become more apparent from the following detailed description when read in conjunction with the accompanying drawings.

FIG. 1 is a schematic view illustrating an example of a structure of a device cooperation system of an embodiment;

FIG. 2 is a block diagram illustrating an example of a mobile terminal of the embodiment;

FIG. 3 is a functional block diagram illustrating an example of units included in a data processing unit of the mobile terminal of the embodiment;

FIG. 4 is a functional block diagram illustrating an example of a projector or an image forming apparatus of the embodiment;

FIG. 5 is a view illustrating an example of a hardware structure of the projector of the embodiment;

FIG. 6 is a view illustrating an example of a hardware structure of the image forming apparatus of the embodiment;

FIG. 7 is a flowchart illustrating an operation of a device cooperation process of the embodiment;

FIG. 8 is a sequence diagram illustrating an example of an operation when a destination is designated of the embodiment;

FIG. 9 is a sequence diagram illustrating an example of an operation when a destination is not designated of the embodiment;

FIG. 10 is a view illustrating an example of a send data table generated by the mobile terminal of the embodiment;

FIG. 11A to FIG. 11D are views illustrating an example of a transition of an operation screen of the mobile terminal;

FIG. 12 is a view illustrating another example of a printer setting screen in which a list of printers is displayed;

FIG. 13 is a view illustrating an example of an operation screen including a projector setting screen;

FIG. 14A to FIG. 14C are views illustrating an example of a method of operating the mobile terminal;

FIG. 15 is a view illustrating another example of the device cooperation system using a connection information sound;

FIG. 16A and FIG. 16B are views illustrating an example of a structure of the device cooperation system using the connection information sound;

FIG. 17 is a sequence diagram illustrating an example of an operation of a device that outputs a connection information sound;

FIG. 18 is a sequence diagram illustrating an example of a mobile terminal that analyzes the connection information sound;

FIG. 19A and FIG. 19B are views illustrating a method of embedding connection information in sound data;

FIG. 20 is a view illustrating a method of extracting the connection information from the sound data;

FIG. 21A is a flowchart illustrating an operation of the mobile terminal;

FIG. 21B is a flowchart illustrating an operation of the projector;

FIG. 22A and FIG. 22B are views illustrating an example of a structure of a device cooperation system using a sound request;

FIG. 23 is a sequence diagram illustrating an example of an operation of a device provided with a sound generation instructing unit;

FIG. 24 is a sequence diagram illustrating an example of an operation of a mobile terminal provided with a sound requesting unit;

FIG. 25 is a flowchart illustrating an operation of the mobile terminal provided with the sound requesting unit;

FIG. 26 is a flowchart illustrating an operation of the device provided with the sound generation instructing unit;

FIG. 27A and FIG. 27B are views for explaining a timing at which the connection information sound is output; and

FIG. 28A and FIG. 28B are views illustrating an example in which another unit is further provided in the device cooperation system.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

### (Device Cooperation System)

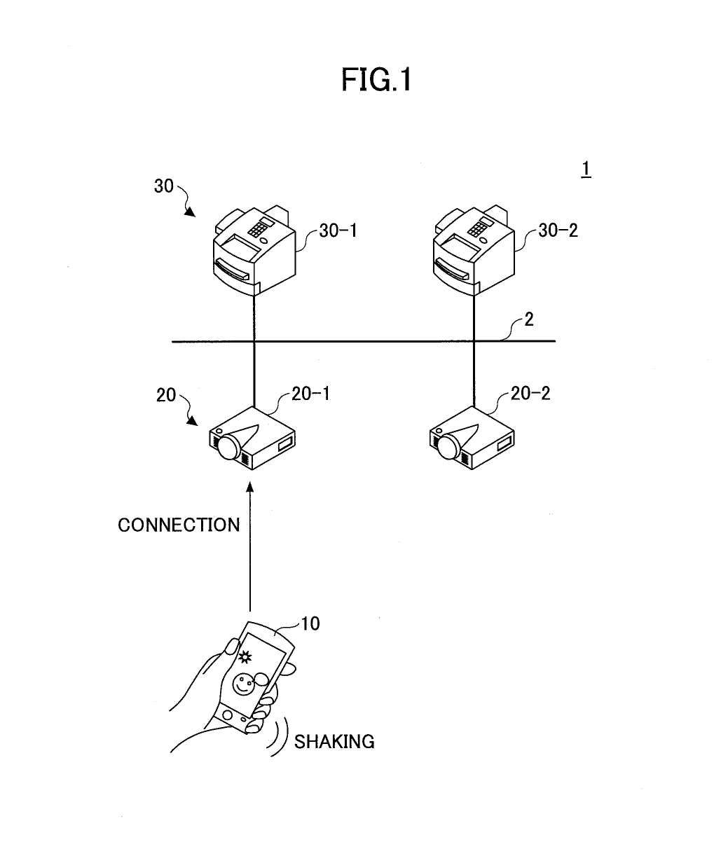

FIG. 1 is a schematic view illustrating an example of a structure of a device cooperation system 1 of the embodiment. The device cooperation system 1 includes a mobile terminal 10, projectors 20-1 to 20-2 and image forming apparatuses 30-1 to 30-2. The mobile terminal 10, the projectors 20-1 to 20-2 and the image forming apparatuses 30-1 to 30-2 are connected via a communication network 2 such as a wireless LAN (Local Area Network), Bluetooth (registered trademark) or the like, for example.

Devices connected to the communication network 2 are not limited to the projectors 20-1 to 20-2 or the image forming apparatuses 30-1 to 30-2, and other devices may be connected to the communication network 2. The number of the projectors and the number of the image forming apparatuses are not limited to the exemplified ones. In the following explanation, the projectors 20-1 to 20-2 are simply referred to as a projector 20 or projectors 20 and the image forming apparatuses 30-1 to 30-2 are also simply referred to as an image forming apparatus 30 or image forming apparatuses 30.

The mobile terminal 10 is a smartphone, a tablet terminal, a mobile phone or the like, for example. In this embodiment, a predetermined motion of the mobile terminal 10 by a user such as “shaking” or the like is previously set as an instruction for the mobile terminal 10 to cooperate with an external device. Thus, when the mobile terminal 10 detects the predetermined motion such as “shaking” or the like of the mobile terminal 10, the mobile terminal 10 cooperates with and communicates with a predetermined external device to send data or the like.

The projector 20 is a projection apparatus that projects an image or animation. The image forming apparatus 30 is a Multifunction Peripheral (MFP), a printer or the like, for example.

In this embodiment, the projector 20 and the image forming apparatus 30 each includes a speaker or the like that outputs a predetermined sound. The predetermined sound may have a frequency of a high-frequency band (more than or equal to 18 kHz, for example) that is out of a threshold of hearing, may be a mosquito sound, may be an error sound or the like, for example, in order not to make a noise.

Upon detecting the predetermined motion such as a “shaking” or the like of the mobile terminal 10, the mobile terminal 10 determines whether a destination (An IP address or the like, for example) to which data is to be sent is designated. When the destination is designated, the mobile terminal 10 sends data or the like that is displayed on a screen of the mobile terminal 10 to the destination, for example.

On the other hand, when the destination is not designated, the following operation is performed. One or more external devices such as the projectors 20 and the image forming apparatuses 30 are configured to output predetermined sounds, which are different from each other. Then, the mobile terminal 10 selects a nearby external device from the one or more external devices that output the predetermined sounds, respectively, based on the output predetermined sounds to cooperate therewith. Thereafter, the mobile terminal 10 sends the data or the like to the selected external device. The predetermined sound may be a sound including a predetermined pattern corresponding to the respective external device for specifying the external device, a connection information sound for specifying an address such as an IP address or the like of the respective external device or the like, for example.

For the example illustrated in FIG. 1, the projectors 20-1 to 20-2 and the image forming apparatuses 30-1 to 30-2 output predetermined sounds, which are different from each other. Thus, the mobile terminal 10 is capable of easily communicating with a nearest external device, with which the user desires to have a communication, by collecting the predetermined sound output from the nearest device in order to specify the nearest device.

The mobile terminal 10 is capable of controlling the projector 20 to project sent data when having a device communication with the projector 20. The mobile terminal 10 is also capable of controlling the image forming apparatus 30 to print out sent data when having a device communication with the image forming apparatus 30.

In order to have the one or more external devices to output the predetermined sounds, respectively, the following operation is performed. The mobile terminal 10 may previously store a plurality of sets of sound data (including animation) of the predetermined sounds, respectively. Then, the mobile terminal 10 may correspond the sets of the sound data with the one or more external devices, respectively. Thereafter, the mobile terminal 10 may send the sets of the sound data to the corresponding external devices to have the external devices output the predetermined sounds, respectively. An example in which the connection information sound for specifying an address or the like of the respective device is output from each of the external devices will be explained later.

### (Mobile Terminal 10)

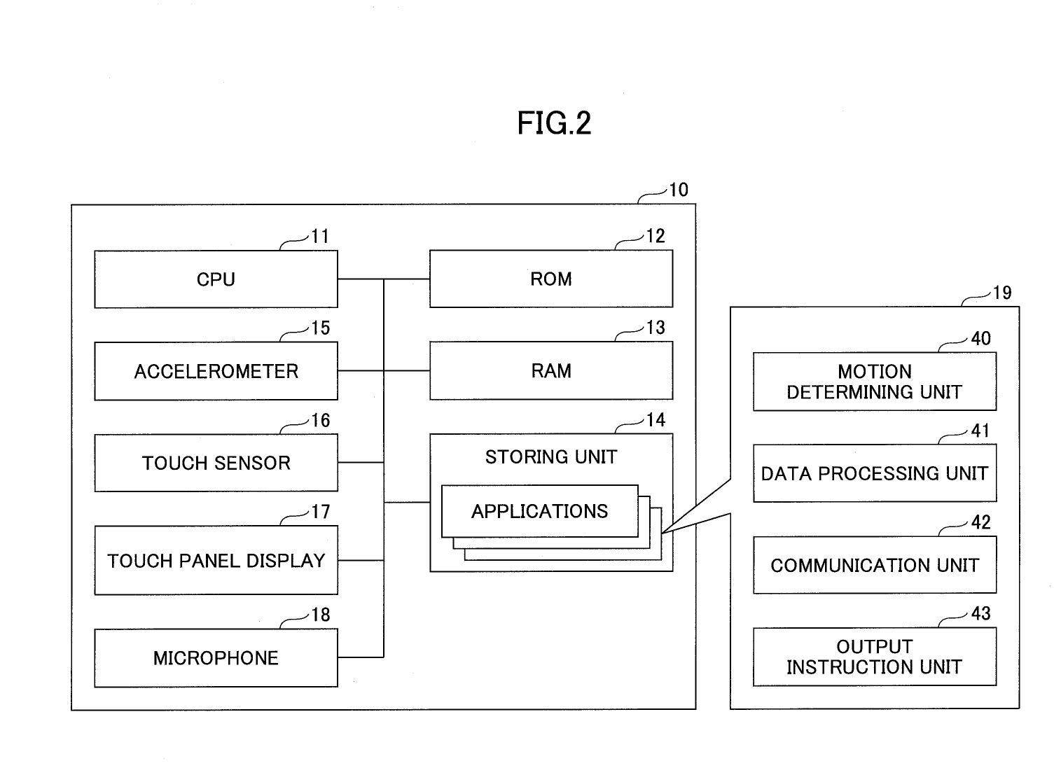

FIG. 2 is a block diagram illustrating an example of the mobile terminal of the embodiment. As shown in FIG. 2, the mobile terminal 10 includes a Central Processing Unit (CPU) 11, a Read Only Memory (ROM) 12, a Random Access Memory (RAM) 13, a storing unit 14, an accelerometer 15, a touch sensor 16, a touch panel display 17 and a microphone 18.

The CPU 11 controls the entirety of the mobile terminal 10. The CPU 11 includes various chip sets and is connected to other devices via the chip sets.

The ROM 12 is a read only memory used for storing programs or data, for example.

The RAM 13 is a writable and readable memory used for developing programs or data, drawing an image for a printer, or the like.

The storing unit 14 is a storage for storing image data, sound data, programs, font data, form data or the like, for example. The storing unit 14 stores various applications 19. The storing unit 14 is composed of a generally used storage media such as a Hard Disk Drive (HDD), an optical disk, a memory card or the like, for example.

The accelerometer 15 detects an operation of the mobile terminal 10. The accelerometer 15 continuously obtains parameters with a predetermined time interval. Specifically, the accelerometer 15 obtains an X value, a Y value and a Z value of 3 axes of XYZ, respectively. Further, the accelerometer 15 obtains rate of change per unit time (acceleration of gravity) ΔX, ΔY and ΔZ of the X value, the Y value and the Z value and time interval tX, tY and tZ between a change of the X value, the Y value and the Z value change, respectively, for example.

The touch sensor 16 is an operation unit that detects an operation to the touch panel display 17. The touch sensor 16 obtains parameters at timing when a contact to the touch panel display 17 is detected, or a related program is selected. The touch sensor 16 obtains a touch event, a positional coordinate (Vx, Vy) at which the touch panel display 17 is contacted, the number of contacted points, a variation (ΔVx, ΔVy) of the positional coordinate and a variation per unit time (tVx, tVy), as the parameters.

The touch panel display 17 displays various data (data to be projected by the projector 20, a thumbnail image, test data or the like, for example) or displays an operation screen for obtaining predetermined input data by an operation of a user.

The microphone 18 is an example of a sound collection device that collects the predetermined sound.

The applications 19 have a function to control output to the external devices, for example. The applications 19 include one or more programs that perform an operation process, a data process, a communication process, an output instruction process or the like. Each of the programs is loaded on the RAM 13 and is executed by the CPU 11. With this configuration, the applications 19 provide a motion determining unit 40, a data processing unit 41, a communication unit 42 and an output instruction unit 43. The applications 19 provide the functions of the units when the application programs are installed in the mobile terminal 10.

The motion determining unit 40 determines a motion of the mobile terminal 10 or an operation to the touch panel display 17 based on values obtained by the accelerometer 15 and the touch sensor 16, for example.

An operation of the motion determining unit 40 based on parameters obtained from the accelerometer 15 is explained in the following.

The motion determining unit 40 determines a direction of the mobile terminal 10 based on the X value, the Y value and the Z value of the 3 axes of XYZ, determines variation in the direction of the mobile terminal 10 based on the acceleration of gravity ΔX, ΔY and ΔZ of the 3 axes of XYZ and determines the predetermined motion such as “shaking”, “inclining” or the like of the mobile terminal 10 by a user. Further, the motion determining unit 40 determines the number of times of shaking, for example, based on the time interval tX, tY and tZ.

An operation of the motion determining unit 40 based on parameters obtained from the touch sensor 16 is explained in the following.

The motion determining unit 40 determines whether a touching operation to the touch panel display 17, a separating operation from the touch panel display 17, a continuous touching operation to the touch panel display 17, a continuous separating operation from the touch panel display 17 or the like is detected based on a touch event. Further, the motion determining unit 40 determines a contacted position of the touch panel display 17, which data or a button on the touch panel display 17 is selected, or the like based on a coordinate (Vx, Vy) of the contacted position, for example.

The motion determining unit 40 determines the number of fingers or operation devices such as touch pens or the like that contacted the touch panel display 17 at the same time based on the number of contacted points. The motion determining unit 40 determines the moved distance of the finger or the like slid on the touch panel display 17 based on the variation (ΔVx, ΔVy) of the positional coordinate. Further, the motion determining unit 40 determines a speed of a movement of the finger or the like on the touch panel display 17 based on the variation per unit time (tVx, tVy).

Further, the motion determining unit 40 determines that the predetermined motion such as “shaking” or the like of the mobile terminal 10 is repeatedly performed when the same motion of the mobile terminal 10 is detected for more than or equal to twice, for example. It means that the motion determining unit 40 is capable of differentiating a motion of the mobile terminal 10 in which the mobile terminal 10 is shaken once and a motion in which the mobile terminal 10 is continuously shaken more than or equal to twice.

Further, the motion determining unit 40 determines that the “shaking” motion is performed when an absolute value of the acceleration of gravity ΔX, ΔY and ΔZ is more than or equal to a predetermined threshold value. Further, the motion determining unit 40 determines that the predetermined motion such as “shaking” or the like of the mobile terminal 10 is repeatedly performed when the time interval tX, tY and tZ between the same motions of the mobile terminal 10 is less than or equal to a predetermined period Tmax seconds.

However, there may be a case that the acceleration of gravity momentarily becomes weak and then recovers to become more than or equal to the predetermined threshold value while the mobile terminal 10 is being shaken only once. Thus, in order not to determine such a case as a case where the predetermined motion of the mobile terminal 10 is repeatedly performed, the motion determining unit 40 is configured not to determine that the predetermined motion such as “shaking” or the like of the mobile terminal 10 is repeatedly performed when a period at which the acceleration of gravity becomes less than the threshold value is less than or equal to Tmin seconds. It means that the motion determining unit 40 determines that the predetermined motion such as “shaking” or the like of the mobile terminal 10 is repeatedly performed when the time interval tX, tY and tZ satisfies Tmax≧tX, tY and tZ≧Tmin and the absolute value of the acceleration of gravity ΔX, ΔY and ΔZ is more than or equal to a predetermine (ΔX, ΔY, ΔZ) becomes more than or equal to the predetermined threshold value.

The storing unit 14 stores processes to be performed allocated to motion patterns, respectively. The data processing unit 41 determines a process to be performed allocated to the motion pattern determined by the motion determining unit 40 and performs data processing based on the determined process to be performed. For example, as the process to be performed, an instruction to output data or the like displayed on the touch panel display 17 to an external device such as the projector 20 or the image forming apparatus 30 is allocated to the “shaking” motion of the mobile terminal 10.

When outputting data to the image forming apparatus 30, the data processing unit 41 generates image data for printing in accordance with the “shaking” motion, and sends the image data to the output instruction unit 43. Specifically, the data processing unit 41 determines partial data of the image data to be displayed on the touch panel display 17 and displays a thumbnail image of the partial data in a thumbnail display area of the touch panel display 17 while associating with applications.

The thumbnail image displayed in the thumbnail display area is capable of being switched to another thumbnail image of another partial data by an operation of sliding the touch panel display 17 in a lateral or vertical direction by a finger, a touch pen or the like. Here, a process to switch a thumbnail image is allocated to a motion of sliding the thumbnail image displayed on the touch panel display 17 by the finger or the like.

A specific operation of the data processing unit 41 will be explained later.

The communication unit 42 connects the mobile terminal 10 with other external devices and sends and receives data between the other external devices via the communication network 2. The communication unit 42 receives information regarding devices (device information, device condition information or the like) from devices connected with the mobile terminal 10 via the communication network 2, for example.

Further, the communication unit 42 has a function of an identification data sending unit that sends the plurality of sets of sound data (including animation files) of the predetermined sounds as identification data for identifying external devices to the external devices, respectively. The predetermined sounds (predetermined patterns) may have a frequency of a high-frequency band (more than or equal to 18 kHz, for example) that is out of a threshold of hearing and is previously set in accordance with a numeric value such as “1111”, for example.

The identification data may be any information capable of identifying a respective external device. The identification data may be sound data including the predetermined pattern or sound data obtained by converting an IP address or the like using a specific frequency. Alternatively, the identification data may be an instruction for an external device to output sound data including the predetermined pattern that is previously stored in the external device.

The output instruction unit 43 accepts an instruction from the data processing unit 41 and instructs the projector 20 to project data or the image forming apparatus 30 to print data, for example.

### (Data Processing Unit 41 of Mobile Terminal 10)

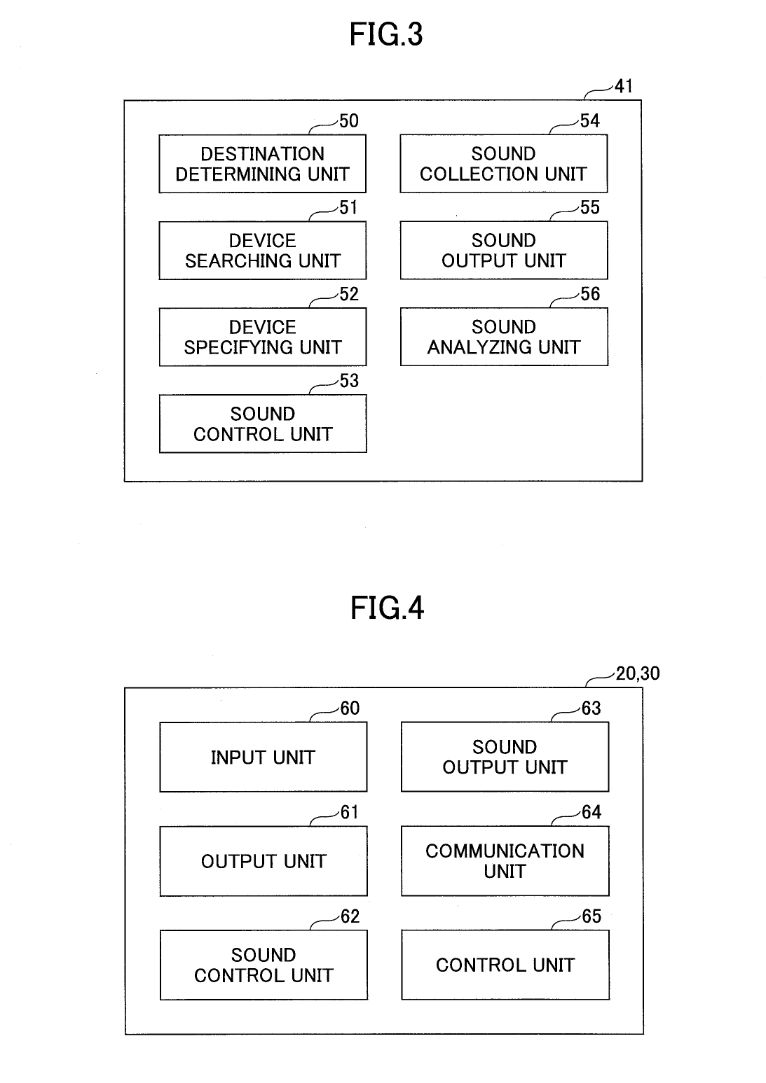

FIG. 3 is a functional block diagram illustrating an example of units included in the data processing unit 41 of the mobile terminal 10. As illustrated in FIG. 3, the data processing unit 41 of the mobile terminal 10 includes a destination determining unit 50, a device searching unit 51, a device specifying unit 52, a sound control unit 53, a sound collection unit 54, a sound output unit 55 and a sound analyzing unit 56.

When the motion determining unit 40 determines that a “shaking” motion of the mobile terminal 10, which is allocated to the process to be performed, the instruction to output data or the like displayed on the touch panel display 17 to the external device, is performed, the destination determining unit 50 determines whether a destination (an IP address or the like, fore example) to send the data is previously designated by a user via a setting screen or the like, for example.

When the destination determining unit 50 determines that the destination is not designated, the device searching unit 51 searches an external device to become the destination via the communication network 2, for example. At this time, the device searching unit 51 may broadcast external devices connected to the communication network 2 or may search the external device via Bluetooth. The method of searching the external device by the device searching unit 51 is not limited so and other communication methods may also be used.

The device specifying unit 52 obtains a plurality of sets of sound data each including a predetermined pattern for specifying an external device from the storing unit 14 and generates a send data table by corresponding the plurality of sets of the sound data to a plurality of the external devices, respectively. Then, the plurality of sets of the sound data are sent to the corresponding external devices and the external devices output the sounds based on the sound data, respectively.

The sound control unit 53 controls collection of a sound by the sound collection unit 54, outputting of a sound by the sound output unit 55 and analyzing of a sound by the sound analyzing unit 56.

The sound collection unit 54 collects a predetermined sound from the microphone 18 based on the control signal from the sound control unit 53 at a necessary time, periodically, or at a predetermined timing, and converts the collected sound into an electrical signal.

When the sound collection unit 54 obtains sound data, the sound control unit 53 controls the sound analyzing unit 56 to analyze the sound data.

The sound analyzing unit 56 analyzes the sound data obtained from the sound collection unit 54 based on the control signal from the sound control unit 53, and extracts information or the like included in the predetermined sound based on the analyzed result. For example, the sound analyzing unit 56 is capable of extracting the predetermined pattern included in the sound data obtained from the sound collection unit 54, however, this is not limited so.

The device specifying unit 52 refers to the send data table and specifies an external device that outputs the predetermined sound using a predetermined pattern analyzed by the sound analyzing unit 56.

The sound output unit 55 outputs a predetermined sound from a sound output device such as a speaker or the like, for example, by a control signal from the sound control unit 53.

### (Projector 20, Image Forming Apparatus 30: Functional Block)

FIG. 4 is a functional block diagram illustrating an example of the projector 20 or the image forming apparatus 30. The functional block illustrated in FIG. 4 expresses an example of units used in the device cooperation process of the embodiment. As shown in FIG. 4, the projector 20 or the image forming apparatus 30 includes an input unit 60, an output unit (display output unit) 61, a sound control unit 62, a sound output unit 63, a communication unit 64 and a control unit 65.

The input unit 60 is composed of a pointing device, a touch panel, a hard key or the like, and accepts an input from a user or the like such as a starting, ending or the like of various instructions.

The output unit 61 outputs a content input by the input unit 60, a content executed based on the input content, data received from the outside via the network 20 or the like, for example. For the projector 20, the output unit 61 outputs data to be projected on a wall surface, a screen or the like, for example. For the image forming apparatus 30, the output unit 61 outputs data to be printed on a paper medium or the like, for example.

The sound control unit 62 controls output of a sound from the sound output unit 63. The sound control unit 62 controls the sound output unit 63 to play and output the sound data received from the mobile terminal 10, for example.

The sound output unit 63 has the same function as the sound output unit 55 of the mobile terminal 10 explained above with reference to FIG. 3. The sound output unit 63 outputs a predetermined sound from a sound output device such as a speaker or the like, for example.

The communication unit 64 sends and receives data between other devices via the communication network 2. The communication unit 65 stores connection information such as an IP address or the like for connecting with other devices such as the mobile terminal 10 via the communication network 2, for example.

The control unit 65 controls the entirety of the device.

### (Projector 20: Hardware Structure)

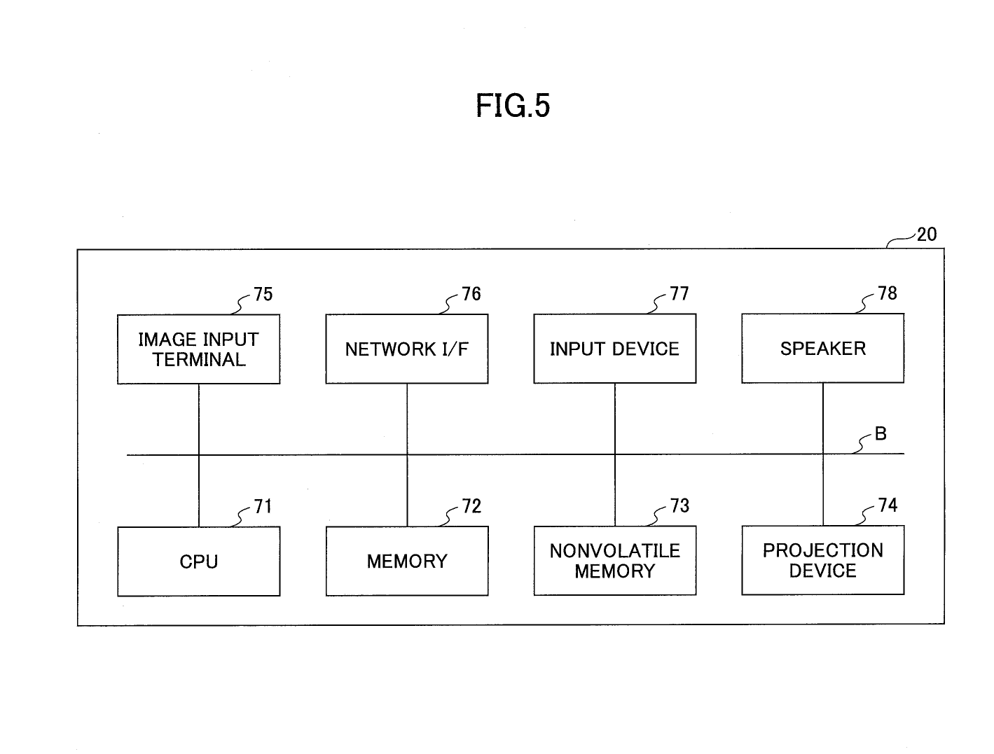

FIG. 5 is a view illustrating an example of a hardware structure of the projector 20 of the embodiment. As shown in FIG. 5, the projector 20 includes a CPU 71, a memory 72, a nonvolatile memory 73, a projection device 74, an image input terminal 75, a network interface (I/F) 76, an input device 77 and a speaker 78.

The CPU 71 is an arithmetical unit that controls the entirety of the projector 20.

The memory 72 stores data necessary for the CPU 71 for various processes. The nonvolatile memory 73 stores programs or the like for actualizing the various processes by the CPU 71.

The projection device 74 is a device that projects data (document or the like) obtained from the mobile terminal 10. The projection device 74 projects light illuminated by a liquid crystal panel and enlarged by an optical system including lens or the like, for example. The method of projecting by the projection device 74 is not limited so, and a Light Emitting Diode (LED) may be used as a light source.

The image input terminal 75 is used when receiving and projecting a screen image from a Personal Computer (PC) or the like.

The network I/F 76 connects the projector 20 to the mobile terminal 10 via the communication network 2 and sends and receives data between the connected mobile terminal 10.

The input device 77 is composed of a button, a remote-control receiver, a card reader that reads data from an IC card or the like, for example, and accepts an operational instruction from the user. The input device 77 may be configured to include a keyboard.

The speaker 78 outputs a predetermined sound by playing the sound data obtained from the mobile terminal 10, for example.

With this structure, by outputting a predetermined sound, the projector 20 is capable of being connected with the mobile terminal 10 so that the projector 20 can project data received from the mobile terminal 10, for example.

### (Image Forming Apparatus 30: Hardware Structure)

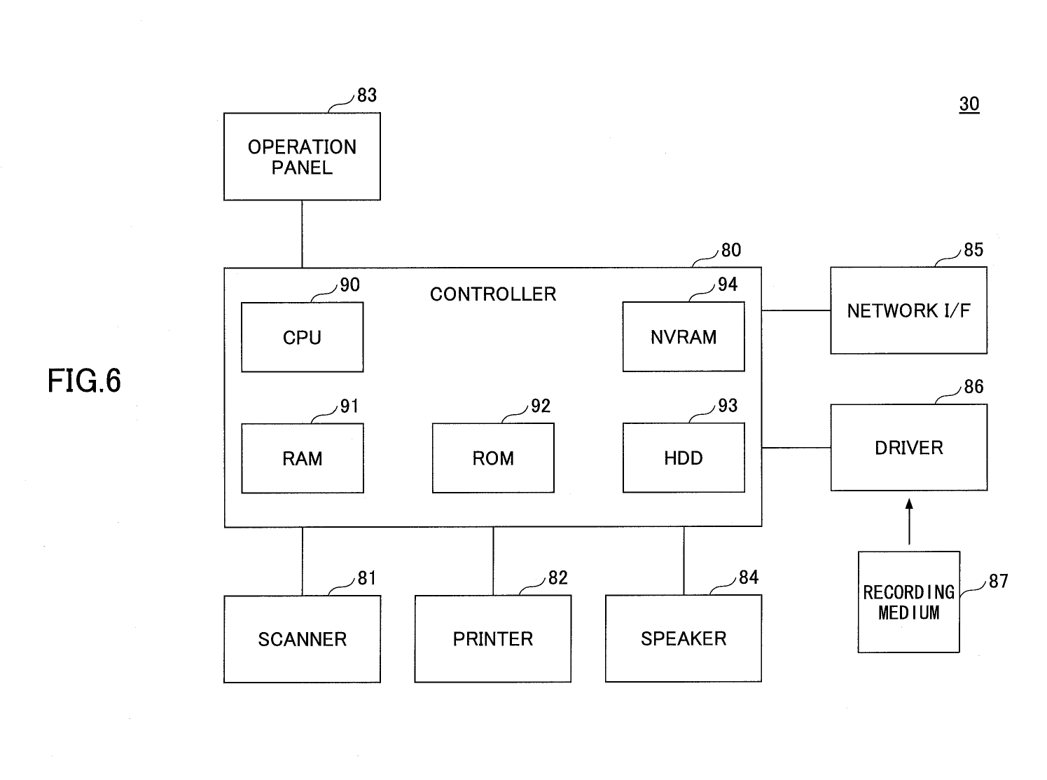

FIG. 6 is a view illustrating an example of a hardware structure of the image forming apparatus 30 of the embodiment. As shown in FIG. 6, the image forming apparatus 30 includes a controller 80, a scanner 81, a printer 82, an operation panel 83, a speaker 84, a network interface (I/F) 85 and a driver 86.

The controller 80 includes a CPU 90, a RAM 91, a ROM 92, a HDD 93, a Non Volatile RAM (NVRAM) 94 and the like.

The CPU 90 actualizes various functions by processing programs loaded on the RAM 68.

The RAM 91 is used as a memory area for loading programs, a work area for the loaded programs or the like. The ROM 92 stores various programs and data used by the programs.

The HDD 93 stores various programs and data used by the programs. The NVRAM 94 stores various setting data or the like.

The scanner 81 is hardware (image reading unit) for reading image data from a document. The printer 82 is hardware (printing unit) for printing print data on a printing medium. The operation panel 83 is hardware including an input unit such as buttons or the like for accepting an input by the user, a display unit such as a liquid crystal panel, or the like.

The speaker 84 outputs a predetermined sound by playing the sound data obtained from the mobile terminal 10, for example.

The network I/F 85 is hardware to connect the image forming apparatus 30 to the mobile terminal 10 via the communication network 2 and sends and receives data between the connected mobile terminal 10. The driver 86 is used for reading a program stored in a recording medium 87. It means that in the image forming apparatus 30, the program stored in the recording medium 87, in addition to the program stored in the ROM 92, is also loaded to the RAM 91 and is executed.

The recording medium 87 may be, for example, a CD-ROM, Universal Serial Bus (USB) memory or the like. However, the recording medium 87 is not limited to a specific one and the driver 86 may be substituted by hardware corresponding to the kind of the recording medium 87.

With this structure, by outputting a predetermined sound, the image forming apparatus 30 is capable of being connected with the mobile terminal 10 so that the image forming apparatus 30 can print data received from the mobile terminal 10, for example.

### (Device Cooperation Process)

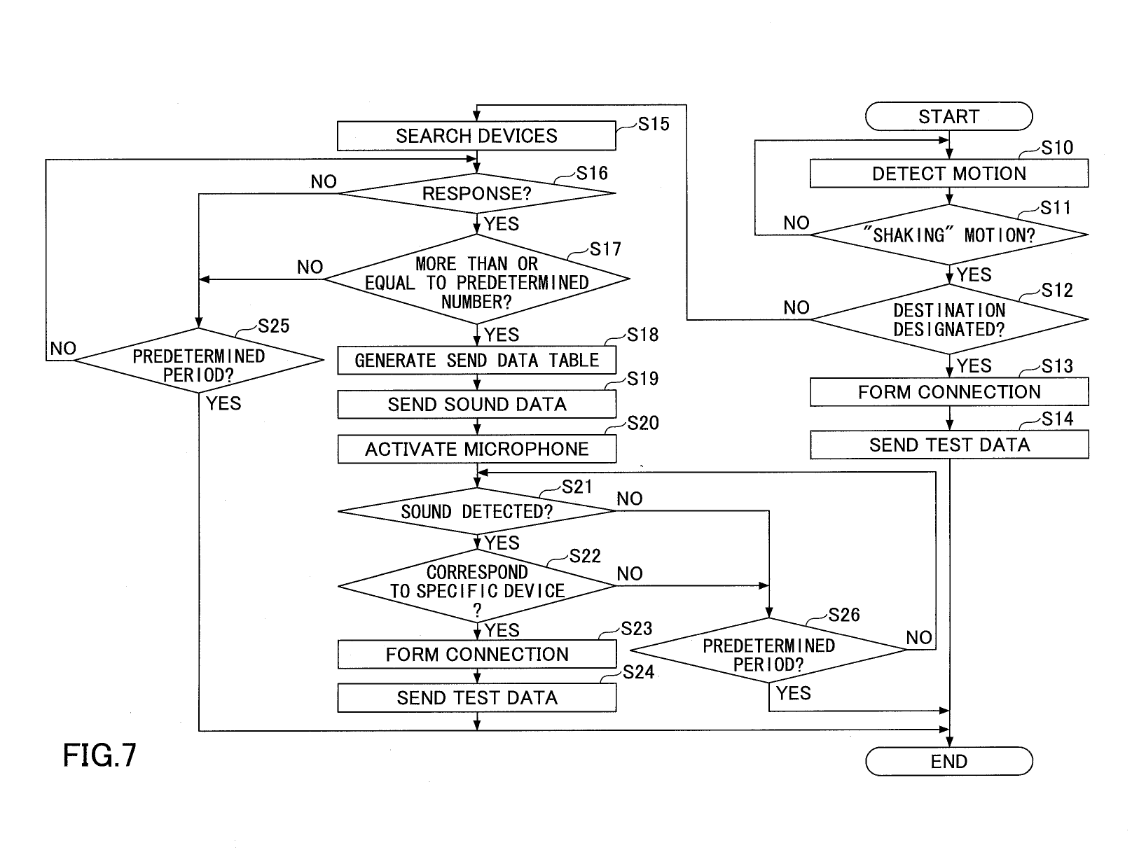

FIG. 7 is a flowchart illustrating an operation of a device cooperation process of the embodiment.

As shown in FIG. 7, at the mobile terminal 10, when the motion determining unit 40 detects a motion (S10), the motion determining unit 40 determines whether the detected motion is the “shaking” motion, which is an example of the predetermined motion (S11).

When the motion determining unit 40 determines that the detected motion is not the “shaking” motion (NO in S11), the process returns to S10.

On the other hand, when the motion determining unit 40 determines that the detected motion is the “shaking” motion (YES in S11), the destination determining unit 50 determines whether the destination is designated (S12). Here, before the process of S11, the user may previously designate an IP address or the like of an external device based on a response from the external device by searching an external device via the communication network 2 or the like. In such a case, the destination determining unit 50 determines that the destination is designated.

When the destination determining unit 50 determines that the destination is designated (YES in S12), the communication unit 42 forms a connection with the designated destination (S13), and sends test data for confirming the user whether the connected external device is appropriate for the destination (S14).

After the process of S14, the mobile terminal 10 sends data to the connected external device after being confirmed by the user and ends the process. The test data is explained later.

Meanwhile, when the destination determining unit 50 determines that the destination is not designated (NO in S12), the device searching unit 51 searches and broadcasts (Probe Request, for example) external devices for the external devices to send device information or the like (S15).

Then, the device searching unit 51 determines whether one or more responses (Probe Response, for example) are obtained from one or more external devices via the communication network 2 (S16).

When the device searching unit 51 determines that the one or more responses are obtained (YES in S16), the device searching unit 51 sends requests for obtaining device condition information to the external devices that have responded based on the device information of the external devices included in the responses, respectively. The device information includes, for example, an IP address for connecting with the respective external device, device type (projector, image forming apparatus or the like, for example) and information for specifying the kinds of the external device.

Then the device searching unit 51 determines whether the number of candidate external devices to communicate with (hereinafter, referred to as “communication candidates”) is more than or equal to a predetermined number based on the device condition information (information such as ON/OFF condition of a power source, input condition or the like) obtained from the external devices (S17).

Here, the external devices capable of being connected to the communication network 2 or the like may be determined as the “communication candidates”. Further, for the projector, the external devices that are not currently projecting images (not currently used) may be determined as the “communication candidates”. The predetermined number may be a plurality of numbers, for example, three dr more. With this configuration, the possibility that a device desired by the user is included in the communication candidates can be increased.

When the device searching unit 51 determines that the number of the communication candidates is more than or equal to the predetermined number (YES in S17), the device searching unit 51 finishes searching of the external devices. Then, the device specifying unit 52 obtains the predetermined number of sets of sound data (including animation files, for example) each including a predetermined pattern for specifying a respective external device from the storing unit 14. Thereafter, the device specifying unit 52 generates a send data table in which the obtained sets of sound data are corresponded to respective communication candidates (S18). An example of the send data table will be explained later.

Then, the communication unit 42 sends the sets of the sound data that correspond with the external devices to the external devices, respectively, based on the send data table via the communication network 2 (S19).

Then, the mobile terminal 10 activates the microphone 18 (S20), and determines whether a sound (or voice) is detected by the sound collection unit (S21).

When the mobile terminal 10 determines that the sound is detected (YES in S21), the sound analyzing unit 56 analyzes the detected sound and extracts a predetermined pattern. Then, the device specifying unit 52 determines whether the extracted predetermined pattern matches the predetermined pattern included in the sound data corresponding to any one of the external devices by referring to the send data table (S22).

When the device specifying unit 52 determines that the extracted predetermined pattern matches the predetermined pattern included in the sound data corresponding to a specific external device (YES in S22), the mobile terminal 10 obtains the IP address of the specific device from the device information of the external device obtained in the above process. Then, the communication unit 42 forms a connection with the specific device (S23). Similar to S14, the mobile terminal 10 sends the test data (S24), sends data to the connected external device after being confirmed by the user and ends the process.

When the device searching unit 51 determines that no response is obtained (NO in S16) or when the device searching unit 51 determines that the number of the communication candidates is less than the predetermined number (NO in S17), whether a predetermined period has passed is determined (S25). When it is determined that the predetermined period has not passed yet (NO in S25), the process returns to S16.

When it is determined that the predetermined period has passed (YES in S25), the process is finished after displaying an error screen, for example. The error screen or the like may include a message to perform the “shaking” motion again or a list of IP addresses of the device information of the external devices obtained in S16 so that the user can manually select the external device to operate.

Further, when the mobile terminal 10 determines that the sound is not detected (No in S21) or when the device specifying unit 52 determines that the extracted predetermined pattern does not match the predetermined pattern included in the sound data corresponding to a specific device (NO in S22), whether a predetermined period has passed is determined (S26). When it is determined that the predetermined period has not passed (NO in S26), the process returns to S21. When it is determined that the predetermined period has passed (YES in S26), the process is finished.

With the above operation, after performing the motion such as “shaking” or the like of the mobile terminal 10, it is possible to easily communicate with a predetermined external device.

Further, in S15, the device searching unit 51 may request external devices to send device condition information in addition to device information. Further, in the processes of S15 to S22, the sound data is sent to an external device every time a new external device is found. With this operation, the processes can be efficiently performed.

Sending of the test data in S14 or S24 may be omitted. However, according to the embodiment, the external device to be connected with is determined based on the sound output from the external device. Thus, if there is a big noise or the like, the external device to be connected with may be wrongly determined. In such a case, the data may be sent to an intended external device.

Thus, according to the embodiment, the mobile terminal 10 may send test data that is not confidential to the external device to be connected with before sending actual important data. Then, the external device that received the test data may output the test data. Therefore, the external device to communicate with can be confirmed by the user. At this time, as the test data is sent, there is no problem even when the external device to be connected with was wrongly determined and the test data is viewed by a third person.

Specifically, for example, when the external device to be connected with is the projector 20, the mobile terminal 10 may send predetermined test data (predetermined screen data, for example) that causes the projector 20 to project a predetermined image on the screen so that the user can confirm whether the determined external device is an intended external device to be connected with by seeing the screen.

Further, specifically, for example, when the external device to be connected with is the image forming apparatus 30, the mobile terminal 10 may send predetermined test data that causes the image forming apparatus 30 to output a predetermined audible sound for the user so that the user can confirm whether the determined external device is an intended external device to be connected with by hearing the sound output from the image forming apparatus 30.

The kind of the external device such as whether the external device to be connected with is the projector 20 or the image forming apparatus 30 can be determined based on the obtained device information. Thus, by storing a plurality of sets of test data corresponding to the kinds of the external device to be connected with, not limited to the projector 20 or the image forming apparatus 30, the mobile terminal 10 is capable of sending test data in accordance with the kind of the external device to the external device to be connected with.

The kind of test data may be determined in accordance with functions provided to the external devices to be connected with. Thus, if the projector 20 has a function to output a sound, the test data to be sent to the projector 20 may be sound data that causes the projector 20 to output a predetermined audible sound for the user. However, for a situation in which the user can easily confirm the external device to be connected with by seeing a screen compared with hearing the sound, the test data to be sent to the projector 20 may be the predetermined screen data or the like, as described above.

Further, a screen to confirm whether a connection with the external device, which is the destination of the test data, can be established may be displayed on the operation screen of the mobile terminal 10.

### (When Destination is Designated)

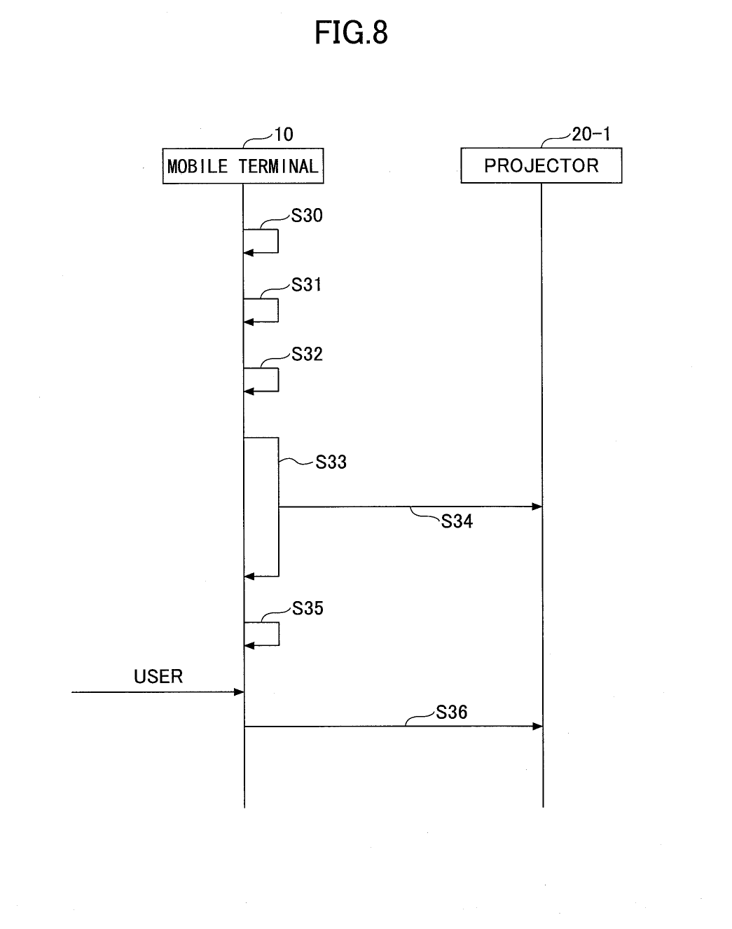

FIG. 8 is a sequence diagram illustrating an example of an operation when the destination is designated. In FIG. 8, an operation between the mobile terminal 10 and the projector 20-1 is exemplified.

In this case, the mobile terminal 10 previously designates the projector 20-1 as the destination to which data is to be sent (S30). When the mobile terminal 10 detects the “shaking” motion (S31), the mobile terminal 10 determines whether the destination is designated (S32).

The mobile terminal 10 determines that the projector 20-1 is designated as the destination, connects to the IP address of the projector 20-1 (S33) and sends test data including a predetermined image to have the projector 20-1 project the predetermined image based on the test data (S34). Then, the mobile terminal 10 displays the predetermined image on the touch panel display 17 so that the user can confirm whether the destination is appropriate. When the mobile terminal 10 accepts the confirmation from the user that the destination is appropriate, the mobile terminal 10 sends actual data to have the projector 20-1 project images based on the actual data (S36). As such, when the destination is previously designated, a device cooperation process is performed between the mobile terminal 10 and the designated destination (projector 20-1).

Although the projector 20 is exemplified, when the image forming apparatus 30 is designated as the destination, a device cooperation process between the mobile terminal 10 and the designated image forming apparatus 30 is performed.

### (When Destination is not Designated)

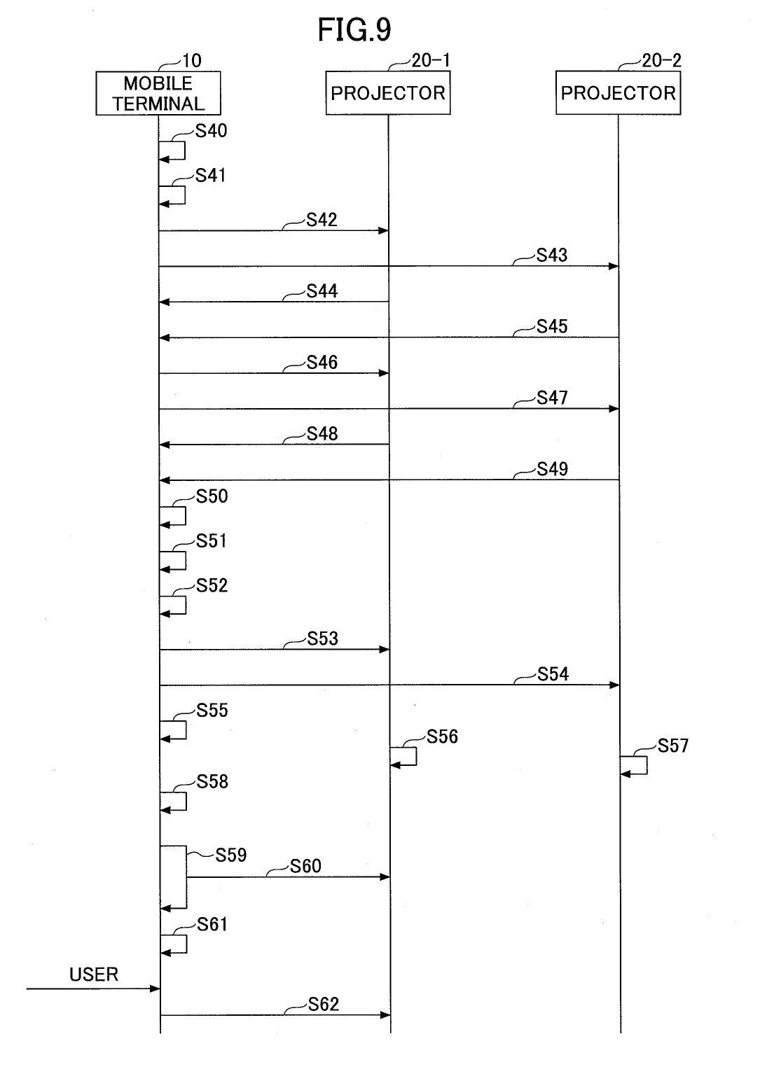

FIG. 9 is a sequence diagram illustrating an example of an operation when the destination is not designated. In FIG. 9, an operation between the mobile terminal 10 and the projector 20-1 and the projector 20-2 is exemplified.

When the mobile terminal 10 detects the “shaking” motion (S40), the mobile terminal 10 determines whether the destination is designated (S41). When it is determined that the destination is not designated, the mobile terminal 10 searches external devices via the communication network 2.

For the example illustrated in FIG. 9, the mobile terminal 10 broadcasts to the projector 20-1 and the projector 20-2 (S42, S43) via the communication network 2.

When the mobile terminal 10 receives responses from the projector 20-1 and the projector 20-2 (S44, S45), the mobile terminal 10 sends requests for obtaining device condition information to the projector 20-1 and the projector 20-2, respectively (S46, S47).

When the mobile terminal 10 receives the device condition information from the projector 20-1 and the projector 20-2 (S48, S49), respectively, the mobile terminal 10 determines the communication candidates based on the device condition information (S50).

For example, for the projector, the device condition information may include information such as input condition information indicating whether the device is currently projecting images, information in accordance with a standard such as a PJ Link or the like. There is a high possibility that the projector which is currently projecting images is already used. Thus, if the projector is to output a sound based on an animation file, the animation file is projected. In such a case, the operation of the projector is interrupted. Thus, the projector which is not currently projecting images may be determined as the communication candidate.

In S42 and S43, the device searching unit 51 may request external devices to send device condition information, which is explained above as S46 and S47, in addition to device information.

When the device searching unit 51 determines that the number of communication candidates is more than or equal to a predetermined number within a predetermined period after searching of the external devices has started (S51), the device searching unit 51 finishes searching of the external devices. Then, the device specifying unit 52 generates a send data table in which sets of sound data (including animation files) having predetermined patterns different from each other for specifying a plurality of external devices, respectively (S52). The predetermined number may be a plural number (more than or equal to two). With this configuration, the possibility that a nearby external device is included in the communication candidates can be increased.

The mobile terminal 10 sends sound data 1 to the projector 20-1 (S53) and sends sound data 2 to the projector 20-2 (S54) in accordance with the send data table.

Then, the mobile terminal 10 activates the microphone 18 and the sound collection unit 54 collects (detects) a sound (S55). The projector 20-1 plays the sound data 1 received from the mobile terminal 10 and outputs the predetermined sound from the sound output unit 63 (S56). The projector 20-2 plays the sound data 2 received from the mobile terminal 10 and outputs the predetermined sound from the sound output unit 63 (S57).

The mobile terminal 10 analyzes the sound collected by the sound collection unit 54 and extracts the predetermined pattern included in the collected sound so that the device that outputs the predetermined sound is specified by referring to the send data table (S58).

The mobile terminal 10 forms a connection with the external device (the projector 20-1, for example) the sound from which is collected first or the volume of the sound from which is the largest, for example (S59). Then, the mobile terminal 10 sends test data that causes the connected external device to project a predetermined image (S60). Thereafter, the mobile terminal 10 displays the predetermined image on the touch panel display 17 (S61) so that the user can confirm that the projector 20-1 is projecting the predetermined image. Then, when the mobile terminal 10 accepts the confirmation from the user that the external device is appropriate, the mobile terminal 10 sends actual data to have the external device project the actual data (S62).

For example, when it is desired to connect the mobile terminal 10 with a nearest external device, the sound from the nearest device external may be collected first, or the volume of the sound from the nearest external device may become the largest. Thus, it is possible to specify the nearest external device based on the predetermined pattern and the mobile terminal 10 can be connected with the external device to perform a device cooperation process.

Here, the predetermined patterns for identifying a plurality of external devices may be a plurality of sets of sound data having different frequencies, respectively, and the sounds output from the plurality of external devices may be collected and analyzed. Further, the mobile terminal 10 may convert the IP addresses or the like included in the device information to a plurality of sets of sound data using different frequencies and send the converted plurality of sets of sound data to the external devices of the respective IP addresses to be output. In this case, the mobile terminal 10 may analyze the IP address included in the sound output from the external device to be connected with a desired device.

Although the projector 20 is exemplified in the above case, the same processes can be performed for the image forming apparatus 30 and data is sent to the image forming apparatus 30 based on the output sound so that the data is printed or the like by the image forming apparatus 30.

### (Send Data Table)

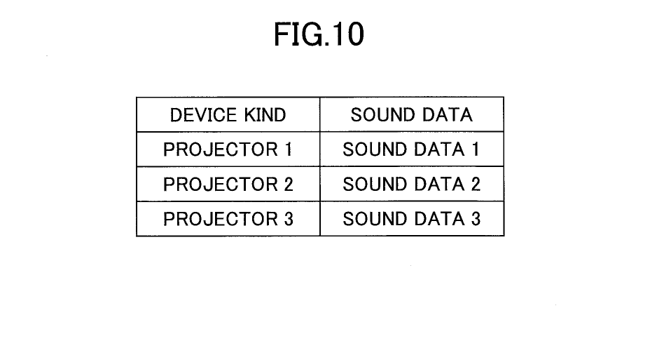

FIG. 10 is a view illustrating an example of a send data table generated by the mobile terminal 10. As shown in FIG. 10, the mobile terminal 10 generates the send data table including items such as a “device kind”, a “sound data” or the like. In FIG. 10, “projector 1” to “projector 3” are exemplified as the “device kind” and “sound data 1” to “sound data 3” are exemplified as the “sound data”.

In the mobile terminal 10, a plurality of sets of sound data including different predetermined patterns, respectively, are stored in the storing unit 14. Thus, the mobile terminal 10 generates the send data table by obtaining the plurality of sets of sound data from the storing unit 14 and performing correspondence between the sound data to the communication candidates, respectively. For the example illustrated in FIG. 10, the communication candidate “projector 1” corresponds to the “sound data 1”.

The mobile terminal 10 collects a sound output by an external device and analyzes the sound to extract a predetermined pattern. Then, the mobile terminal 10 refers to the send data table and determines that the external device that has output the predetermined sound is the “projector 1” when the mobile terminal 10 determines that the sound data including the extracted predetermined pattern is the “sound data 1”.

As described above, the device information obtained when searching external devices include information for specifying the respective external device (device name “projector 1”, for example), an IP address and the like. Thus, the mobile terminal 10 is capable of obtaining the IP address of the “projector 1” from the storing unit 14 by storing the device information in the storing unit 14 when searching external devices so that the mobile terminal 10 can be connected to the respective external device.

### (Preprocessing)

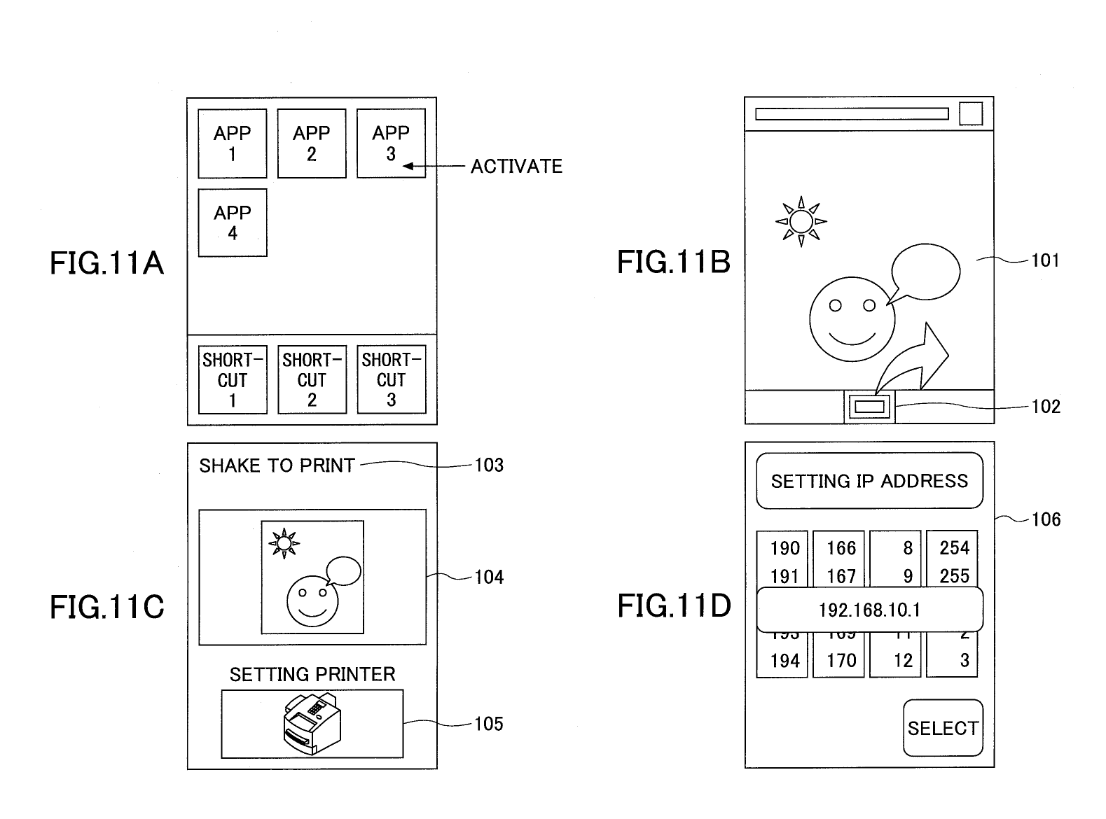

An example of a preprocessing performed in the mobile terminal 10 or the like, before performing the device cooperation process of the embodiment is explained. FIG. 11A to FIG. 11D are views illustrating an example of a transition of an operation screen of the mobile terminal 10. FIG. 11A illustrates an initial screen of the mobile terminal 10. FIG. 11B illustrates a screen of a selected application. FIG. 11C illustrates a print instruction screen. FIG. 11D illustrates a printer setting screen.

Applications stored in the storing unit 14 are displayed on the touch panel display 17 illustrated in FIG. 11A. For example, when one of the applications is selected, the selected application is activated, and then, the screen of the selected application is displayed, as illustrated in FIG. 11B.

It means that selected data 101 such as a selected document file, image data or the like is displayed on the touch panel display 17 illustrated in FIG. 11B. For example, when an association button 102 illustrated in FIG. 11B is operated under a state that the data is selected, the print instruction screen illustrated in FIG. 11C is displayed and the selected data 101 is output to the data processing unit 41. The data processing unit 41 stores the selected data 101 in the storing unit 14.

The print instruction screen illustrated in FIG. 11C includes a message part 103, a thumbnail display area 104 and a printer setting part 105, for example. This screen structure is just an example and a button or the like for setting a print condition may be included.

In the message part 103, a message to the user is displayed. For the example illustrated in FIG. 11C, a message “shake to print” is displayed. However, alternatively, this massage can be arbitrarily changed to a message such as “select printer” or the like, when a destination image forming apparatus is not designated.

In the thumbnail display area 104, a thumbnail image of the selected data 101 is displayed. When the selected data 101 is composed of a plurality of pages, a thumbnail image of one page, in other words, a thumbnail image of partial data is displayed. When the selected data 101 is composed of the plurality of pages and the thumbnail display area 104 is operated by a sliding operation with a finger or the like, another thumbnail image of another page may be displayed. Here, the data processing unit 41 functions as a display area selection unit by switching the thumbnail images in accordance with the operation to the thumbnail display area 104.

In the printer setting part 105, an operation screen for determining the image forming apparatus 30 by which print is performed is displayed. FIG. 11D is an example of the printer setting part 105. In the printer setting screen illustrated in FIG. 11D, the image forming apparatus 30, which is a destination, is determined by operating an IP address designating picker 106 and directly designating the IP address of the image forming apparatus 30.

For example, a function of a destination determining unit can be actualized by determining the image forming apparatus 30 via the printer setting part 105. The IP address of the image forming apparatus 30, which is the designation, is stored in the storing unit 14 as a designated address of the destination.

An operation process using the thumbnail image is explained. This process is started by operating the association button 102, for example. The data processing unit 41 determines whether the selected data 101 is stored in the storing unit 14. When the selected data 101 is stored, the data processing unit 41 generates a thumbnail image to be displayed in the thumbnail display area 104 based on the selected data 101.

When the selected data 101 is not stored, the data processing unit 41 displays a message such as “select file” or the like in the message part 103.

Then, an operation when the thumbnail display area 104 is operated is explained. This process is started when the thumbnail display area 104 is operated while a thumbnail image is displayed in the thumbnail display area 104.

The motion determining unit 40 determines whether the thumbnail image displayed in the thumbnail display area 104 is operated. For this determination, a touch event, a positional coordinate (Vx, Vy), a variation (ΔVx, ΔVy) of the positional coordinate and a variation per unit time (tVx, tVy) obtained by the touch sensor 16 are used.

When it is determined that the thumbnail image is operated, the data processing unit 41 obtains the operating amount, in other words, the moved distance of the finger or the like slid on the touch panel display 17 and the speed from the touch sensor 16 and determines the thumbnail image of the partial data to be displayed.

Specifically, the larger the stroke of the finger or the like is the more a proceeded page is determined to be displayed in the display area. The data processing unit 41 generates a thumbnail image of the page of the determined partial data and displays the thumbnail image in the thumbnail display area 104. On the other hand, when it is determined that no operation to the thumbnail image is detected, the process is finished.

### (Setting of Print Condition)

An example is explained in which the printing number is determined by the number of times of the “shaking” motion of the mobile terminal 10 as an example of a print condition set in the preprocessing. When the “shaking” motion of the mobile terminal 10 is performed, the data processing unit 41 may reset the time and start counting from “0” to count the printing number. The data processing unit 41 may determine that the “shaking” motion of the mobile terminal 10 is finished when a predetermined period has passed after starting the counting and determine the printing number. It means that the data processing unit 41 increases the printing number every time the “shaking” motion is detected.

When the printing number is determined to be more than or equal to one page, the motion determining unit 40 determines whether a touch event to the touch panel display 17 is detected by the touch sensor 16 when the “shaking” motion of the mobile terminal 10 is performed. When the touch event is not detected, the data processing unit 41 sets the print condition to print all of the pages of the selected data 101.

On the other hand, when the touch event is detected, the data processing unit 41 sets the print condition to print only the page displayed in the thumbnail display area 104 among the selected data 101.

The data processing unit 41 generates print data by image converting from the selected data 101, and outputs the generated print data with the print condition such as the printing number or the like to the output instruction unit 43.

According to the above described mobile terminal 10, the user can instruct an external output device just by a simple motion such as “shaking” the mobile terminal 10. Thus, it is convenient for the user because the user can operate the external device without seeing a screen.

Further, as the printing number can be set by the number of times of shaking the mobile terminal 10, the printing number can be easily set for the mobile terminal 10 even when the operation screen of which is small and it is difficult to set the print condition in detail. Further, whether to print all of the pages or just print one page is determined based on whether the touch panel display 17 is contacted when the mobile terminal 10 is shaken. Thus, it is possible for the user to set the range of printing without seeing the operation screen.

Alternatively, an allocated number of pages to a paper may be changed when the “shaking” motion is continuously detected, instead of changing the printing number. Specifically, when the mobile terminal 10 is continuously shaken twice, it means “2 in 1”, when the mobile terminal 10 is continuously shaken three times, it means “4 in 1”, for example. A process to be performed that is to be allocated to the motion pattern may be arbitrarily changed, and a process to select whether to perform duplex printing, whether to perform color/monochrome printing, whether to perform sorting, whether to staple, whether to perform finishing, whether to fold or the like may be previously allocated to the motion pattern and stored in the storing unit 14.

### (Another Example of Printer Setting Screen)

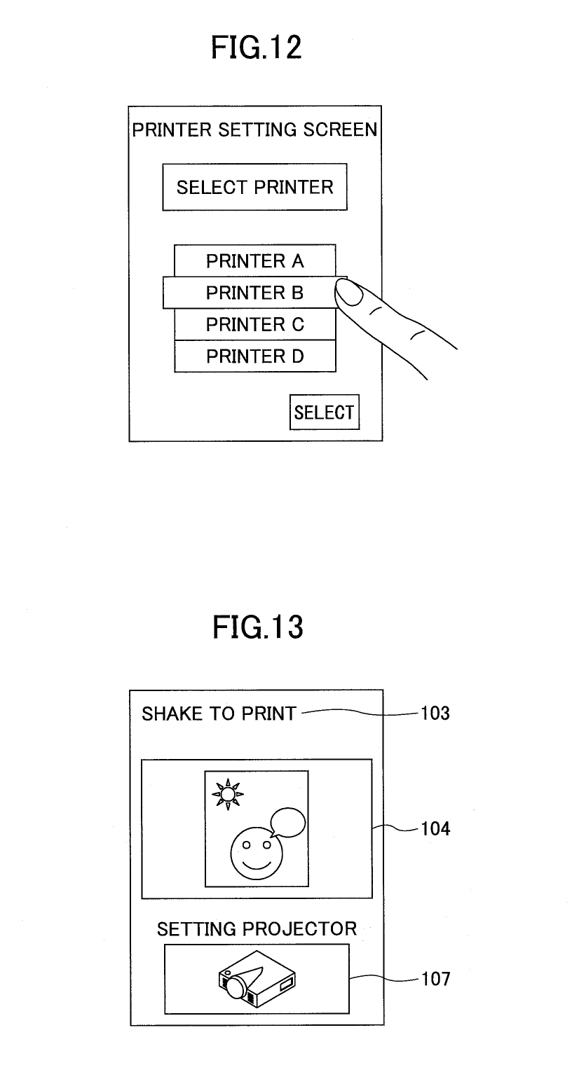

Another printer setting screen set in preprocessing is explained. FIG. 12 is a view illustrating another example of the printer setting screen in which a list of printers is displayed. For the example illustrated in FIG. 11D, the printer is determined by the IP address in the printer setting screen. Alternatively, the printer may be selected from a list of printers.

As shown in FIG. 12, a list of the printers capable of communicating with the mobile terminal 10 may be automatically obtained so that the user can select one of the printers from the list. Specifically, a list of printer drivers installed in the mobile terminal 10 may be obtained. Further, information about printers existing on the communication network 2 may be obtained, without installing the printer drivers. With this configuration, as it is not necessary to input the IP address, it is more convenient for the user to operate.

### (Example of Operation of Other Printing Instruction)

Here, it may be set that only data displayed on the screen is printed when the mobile terminal 10 is shaken while the touch panel display 17 is contacted, instead of printing only one page as described above. This may be applicable for a case when the data is not divided by pages, for example, when an HTML page is displayed using a WEB browser or the like. Further, it may be set that all of the pages are printed regardless of whether the touch panel display 17 is contacted.

The number of times of the “shaking” motion may be counted until when a predetermined period has passed from the first “shaking” motion without resetting and the count value may be set as the printing number.

Motions determined by the motion determining unit 40 as processes to be performed such as an instruction to print or the like may include a motion capable of performing without seeing the screen such as “inclining” or the like in addition to “shaking”. Further, the “shaking” motion may be further differentiated such as shaking upward and downward, shaking leftward and rightward or the like and any variation may be adopted.

Further, a value of a gyro sensor may be obtained in addition to the accelerometer 15.

The mobile terminal 10 and an external device may be connected via another wireless line such as wireless LAN, Bluetooth or the like, or the mobile terminal 10 and the external device may be connected via a wire line via a gateway.

Further, a change of an image to be displayed in the thumbnail display area 104 may be instructed, not by an operation to the touch panel display 17, but by a motion of the mobile terminal 10 such as shaking leftward and rightward, and printing may be instructed by a motion of the mobile terminal 10 such as shaking upward and downward, or the like.

### (When Projector is Selected)

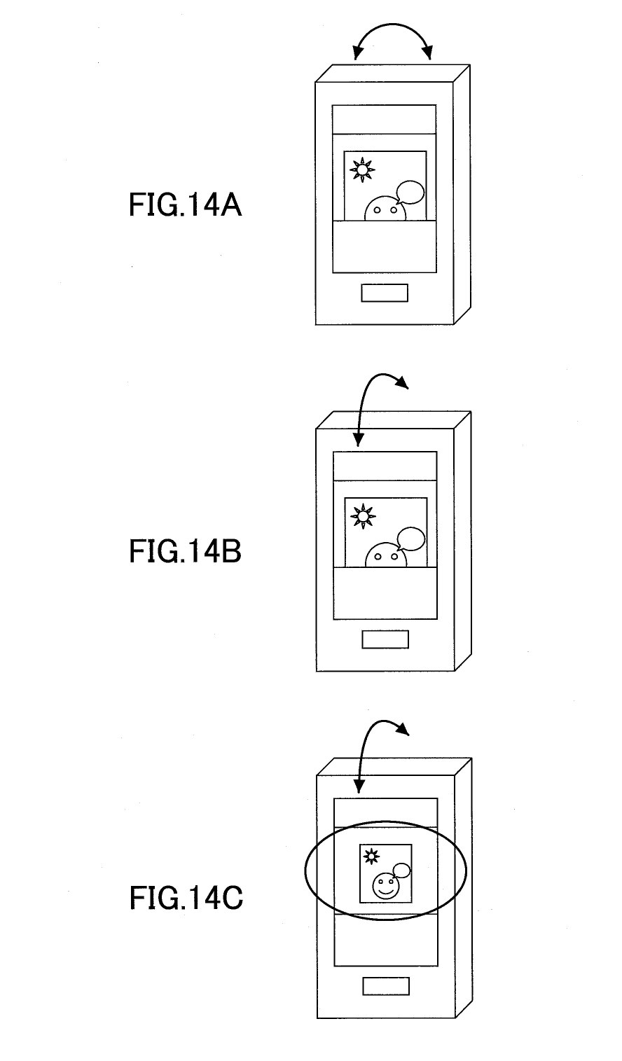

Next, an example in which various settings are performed for the projector is explained as an example of the preprocessing. FIG. 13 is a view illustrating an example of an operation screen including a projector setting screen. FIG. 14A to FIG. 14C are views illustrating an example of a method of operating the mobile terminal 10.

For the example illustrated in FIG. 13, an example in which the projector is designated as the external device to perform a device cooperation process with the mobile terminal 10 is illustrated. For the external device to perform the device cooperation process, a storage or the like may be selected in addition to the image forming apparatus, the projector or the like. With this configuration, an instruction to output data or the like can be simply performed just by a motion of the mobile terminal 10 such as “shaking” or the like. Further, for the example illustrated in FIG. 13, a projector setting part 107 is provided instead of the printer setting part.

As shown in FIG. 14A, when the motion of the mobile terminal 10 “shaking leftward and rightward” is detected, an instruction to output is sent to the selected projector. Further, as shown in FIG. 14B, by shaking the mobile terminal 10 frontward, an instruction to enlarge data output to the projector is made, and by shaking the mobile terminal 10 backward, an instruction to reduce data output to the projector is made. Further, as shown in FIG. 14C, when a “shaking frontward and backward” operation of the mobile terminal 10 while touching the thumbnail display area 104 is detected, the setting of enlarge and reduce is released and the size returns to the initial state.

Further, a display condition of the projector 20 can be set similarly to the above described embodiment of the print condition. For example, the number of pages to be displayed on the screen may be set based on the number of times of the “shaking” motion of the mobile terminal 10, whether to send all of the pages or send only the displayed page may be set based on whether a touch event is detected or the like.

As described above, by allocating processes of changing the output condition of data to motions such as “shaking”, “inclining” or the like in accordance with the kind of external device, an intuitive operation can be actualized.

The above described units may be actualized by software or hardware and the above described processes may be provided in an embedded form in the ROM or the like. The above described processes may be stored in a computer readable recording medium such as a CD-ROM, a flexible disk (FD), a CD-R, a Digital Versatile Disk (DVD) or the like in a form capable of being installed or in an executable form. Further, the above described processes may be stored in a computer connected to a network such as INTERNET or the like and provided by downloading via the network. Further, the above described processes may be provided or delivered via a network such as INTERNET or the like.

Although the image forming apparatus 30 is exemplified as a multifunction device including at least two functions selected from a copying function, a printer function, a scanner function and a facsimile function, the image forming apparatus 30 may be any image forming apparatus such as a copying apparatus, a printer, a scanner apparatus, a facsimile apparatus or the like.

### (Device Cooperation System Using Connection Information Sound)

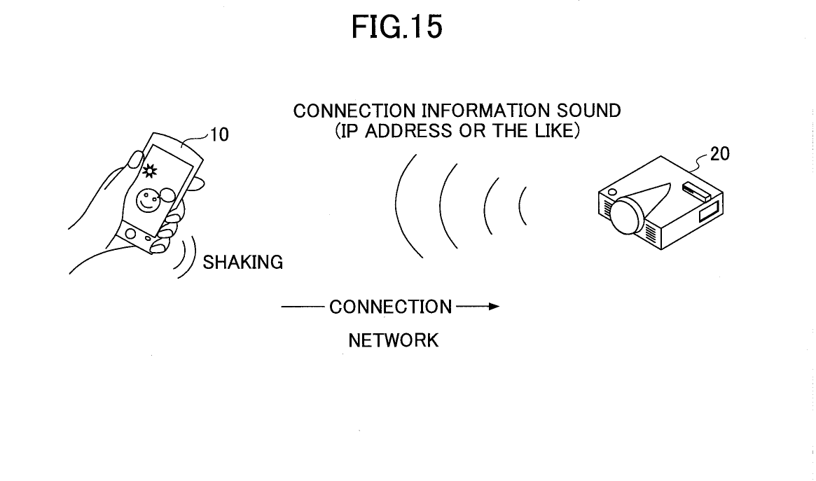

An example of a device cooperation system using a connection information sound is explained as another example of a device cooperation process of the above described device cooperation system 1. FIG. 15 is a view illustrating another example of the device cooperation system using a connection information sound.

In FIG. 15, the mobile terminal 10 detects a “shaking” motion as an example of the predetermined motion, obtains a predetermined sound (connection information sound, for example) output from an external device (here, the projector 20 is exemplified as an example of the external device) when the destination is not designated and connects to the external device based on the connection information included in the sound.

The connection information sound may include, as the connection information, information for specifying an address used when connecting to the external device such as an IP address used when connecting via a LAN, a combination of Service Set Identifier (SSID) for an ad hoc connection and an IP address, a combination of a Media Access Control (MAC) address and a pass key for connection via Bluetooth, or the like, for example.

For example, when the connection information is an IP address, functions of the device cooperation system can be easily actualized by general purpose devices. Further, when the connection information is information using the ad hoc connection, the mobile terminal 10 can be connected to an external device via a connection without using a network via an access point.

For the example illustrated in FIG. 15, when the mobile terminal 10 detects a “shaking” motion, the microphone 18 collects the connection information sound output from the projector 20 and the mobile terminal 10 connects to the projector 20 via the communication network 2 based on the connection information obtained by the analysis of the collected sound.

In the above described case, the mobile terminal 10 can be easily connected to the projector 20 even when the mobile terminal 10 and the projector 20 belong to different subnets. Further, the mobile terminal 10 can be easily connected to a target projector 20 using the connection information obtained from the connection information sound, even when a plurality of projectors 20 are provided in a plurality of conference rooms, respectively.

### (Structure of Device Cooperation System Using Connection Information Sound)

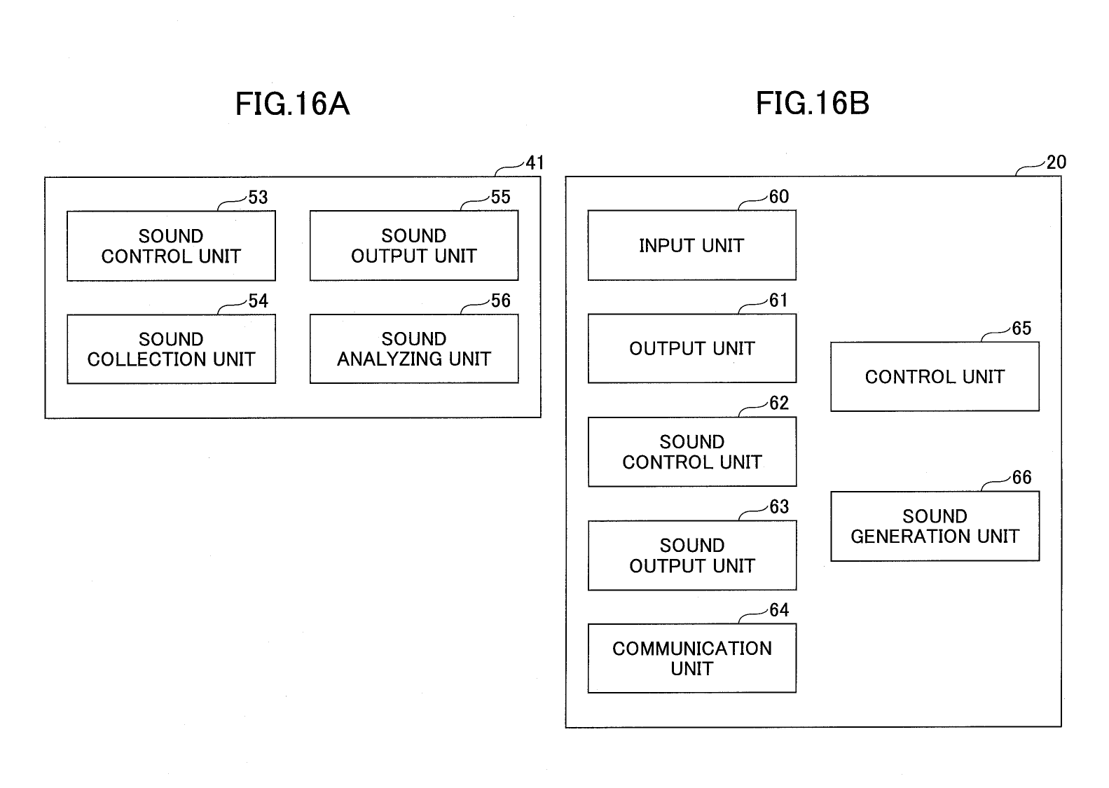

FIG. 16A and FIG. 16B are views illustrating an example of a structure of the device cooperation system using the connection information sound. FIG. 16A illustrates units of the data processing unit 41 of the mobile terminal 10 and FIG. 16B illustrates units (functional blocks) of the projector 20.

As shown in FIG. 16A, the data processing unit 41 of the mobile terminal 10 includes the sound control unit 53, the sound collection unit 54, the sound output unit 55 and the sound analyzing unit 56. The data processing unit 41 illustrated in FIG. 16A is different from the data processing unit 41 illustrated in FIG. 3 in that it does not include the destination determining unit 50, the device searching unit 51 and the device specifying unit 52. Here, only the different points are explained.

The sound control unit 53 may obtain a level of an ambient noise based on the sound obtained by the sound collection unit 54 and may limit the sound data to be analyzed by the sound analyzing unit 56 based on a predetermined threshold value in accordance with the obtained level of the ambient noise, the distance to the projector 20 or the like.

For example, when the distance to the projector 20 is about 1 m, the sound control unit 53 may limit the sound data to be analyzed by the sound analyzing unit 56 based on the volume of the obtained sound such that sound less than or equal to about 50 dB is not analyzed or the like. With this configuration, only the connection information sound obtained from a desired external device can be analyzed based on the distance to the nearby external device to which the mobile terminal 10 is to be connected even when the connection information sounds are obtained from the plurality of external devices.

The sound analyzing unit 56 analyzes the sound data obtained by the sound collection unit 54 to obtain the connection information included in the connection information sound output from the projector 20 or obtain identification data unique to the projector 20 included in identification data sound (projector ID sound) output from the projector 20. The method of obtaining the connection information from the sound data by the sound analyzing unit 56 of the mobile terminal 10 will be explained later.

Then, the mobile terminal 10 is capable of being connected to the external device that has output the connection information sound by the communication unit 42 via the communication network 2 based on the connection information obtained from the sound analyzing unit 56.

As shown in FIG. 16B, the projector 20 includes the input unit 60, the output unit 61, the sound control unit 62, the sound output unit 63, the communication unit 64, the control unit 65 and a sound generation unit 66. The functional block of the projector 20 illustrated in FIG. 16B is different from that of the projector 20 illustrated in FIG. 4 in that it includes the sound generation unit 66. Here, only the different points are explained.

The sound control unit 62 controls the sound generation unit 66 to generate connection information sound and controls the sound output unit 63 to output the sound. The sound control unit 62 previously set the volume of the connection information sound so that the connection information sound can be heard within a predetermined range. Further, for example, the sound control unit 62 may control the sound generation unit 66 to vary the volume of the connection information sound in accordance with the distance to the mobile terminal 10. The user of the mobile terminal 10 may designate the distance to the mobile terminal 10 based on the distance between the mobile terminal 10 and an external device, which is positioned in front of the user, for example. Then, the distance to the mobile terminal 10 designated by the user of the mobile terminal 10 may be sent to the external devices, including the projector 20, when the mobile terminal 10 broadcasts the external devices. For example, when the distance to the mobile terminal 10, a conference room or the like is designated by the mobile terminal 10, the sound control unit 62 may control the sound generation unit 66 to vary the volume of the connection information sound so that the sound output from the projector 20 can reach the mobile terminal 10.

Further, when the projector 20 includes a sound collection unit, the sound control unit 62 may control the sound collection unit to measure ambient noises and control the sound generation unit 66 to vary the volume of the connection information sound based on the measured ambient noises or the distance to the mobile terminal 10.

The sound control unit 62 may control the sound generation unit 66 to generate the connection information sound having a frequency of a high-frequency band (more than or equal to 18 kHz, for example) or the like that is out of a threshold of hearing so that the connection information sound does not become noise.

The sound control unit 62 may control the sound generation unit 66 to generate the connection information sound having a frequency of a frequency bandwidth set differently based on the kind of device (projector, MFP, tablet terminal, PC or the like, for example). With this configuration, the mobile terminal 10 can recognize which kind of external device corresponds to the connection information sound based on the frequency of the sound even when a plurality of external devices exist around the mobile terminal 10. Thus, confusion can be avoided.

The sound generation unit 66 generates predetermined sound data to be output via the sound output unit 63 such as a speaker or the like, for example. For example, the sound generation unit 66 obtains connection information, identification data (ID) unique to the projector 20 or the like from the communication unit 64, embeds it in a sound to generate the connection information sound or the identification data sound (projector ID sound). The method of embedding the connection information or the like in the sound data by the sound generation unit 66 will be explained later.

With the above described structure, the mobile terminal 10 is capable of collecting the connection information sound output from the projector 20 and communicating with the projector 20 which is within a predetermined range by using the connection information obtained from the collected connection information sound.

### (Operational Sequence of Device Outputting Connection Information Sound)

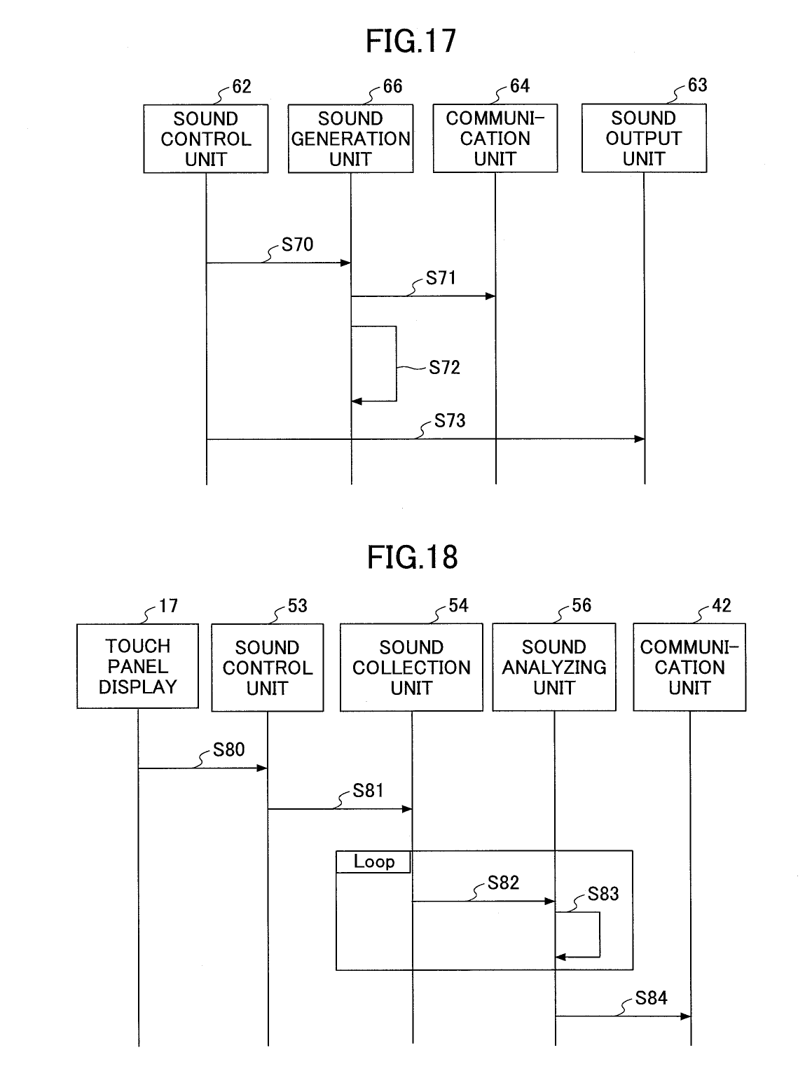

FIG. 17 is a sequence diagram illustrating an example of an operation of a device that outputs a connection information sound. In FIG. 17, the operation of the device is explained using the sound control unit 62, the sound generation unit 66, the communication unit 64 and the sound output unit 63.

As shown in FIG. 17, the sound control unit 62 of the projector 20 controls the sound generation unit 68 to generate a connection information sound (S70). Then, the sound generation unit 66 obtains connection information of itself (information for having a communication with the projector 20) from the communication unit 64 (S71) and embeds the obtained connection information in a sound to generate the connection information sound (S72).

Here, the sound generation unit 66 may embed the connection information in the sound using a Dual-Tone Multi-Frequency (DTMF) method by which information is allocated to sounds of a plurality of frequencies, respectively, or may embed the connection information in the sound by a method that will be explained later.

At this time, the sound generation unit 66 may embed information in the sound using a frequency of a high-frequency band (more than or equal to 18 kHz, for example) that is out of a threshold of hearing. In such a case, as the connection information sound does not become noise, a user can unconsciously connect the mobile terminal 10 to the projector 20. Here, a general method for embedding information in a sound may be used.

Upon receiving the generation of the connection information sound from the sound generation unit 66, the sound control unit 62 controls the sound output unit 63 to output the connection information sound (S73). Then, the sound output unit 63 outputs the connection information sound.

The process of the sound control unit 62 may be started by a trigger such as when an input instruction by the user from the input unit 60 is obtained, when activating the system, when responding to the device search from an external device (mobile terminal 10, for example) via the communication 2, when receiving an instruction to output sound from the external device (mobile terminal 10, for example) via the communication network 2, or the like.

### (Operational Sequence of Mobile Terminal Analyzing Connection Information Sound)

FIG. 18 is a sequence diagram illustrating an example of a mobile terminal that analyzes the connection information sound. In FIG. 18, the operation of the device is explained using the touch panel display 17, the sound control unit 53, the sound collection unit 54, the sound analyzing unit 56 and the communication unit 42.

When a user inputs an instruction to start searching the projector 20 or the like to the touch panel display 17 of the mobile terminal 10, as shown in FIG. 18, the touch panel display 18 outputs a signal indicating to obtain the connection information sounds output from the projectors 20 to the sound control unit 53 (S80).

The sound control unit 53 controls the sound collection unit 54 to collect sounds (S81). Then, the sound collection unit 54 converts the collected sound into sound data and outputs the converted sound data to the sound analyzing unit 56 (S82). The sound analyzing unit 56 analyzes the sound data output from the sound collection unit 54 (S83). When the sound analyzing unit 56 obtains the connection information included in the connection information sound, the sound analyzing unit 56 outputs the obtained connection information to the communication unit 42 (S84).

The method of obtaining the connection information included in the connection information sound is explained. When the connection information is embedded by the above described DTMF method, the sound analyzing unit 56 analyzes the sound including a plurality of specific frequencies using a Fast Fourier Transform (FFT) and obtains the connection information based on the included frequencies. The method of extracting the connection information may be a general method used for extracting information from a sound, or the method described later.

Further, processes of S82 of the sound collection unit 54 and S83 of the sound analyzing unit 56 are looped until the sound analyzing unit 56 obtains the connection information. The communication unit 42 forms a communication with the projector 20 via the communication network 2 using the connection information obtained from the sound analyzing unit 56.

### (Method of Embedding Connection Information in Sound Data)

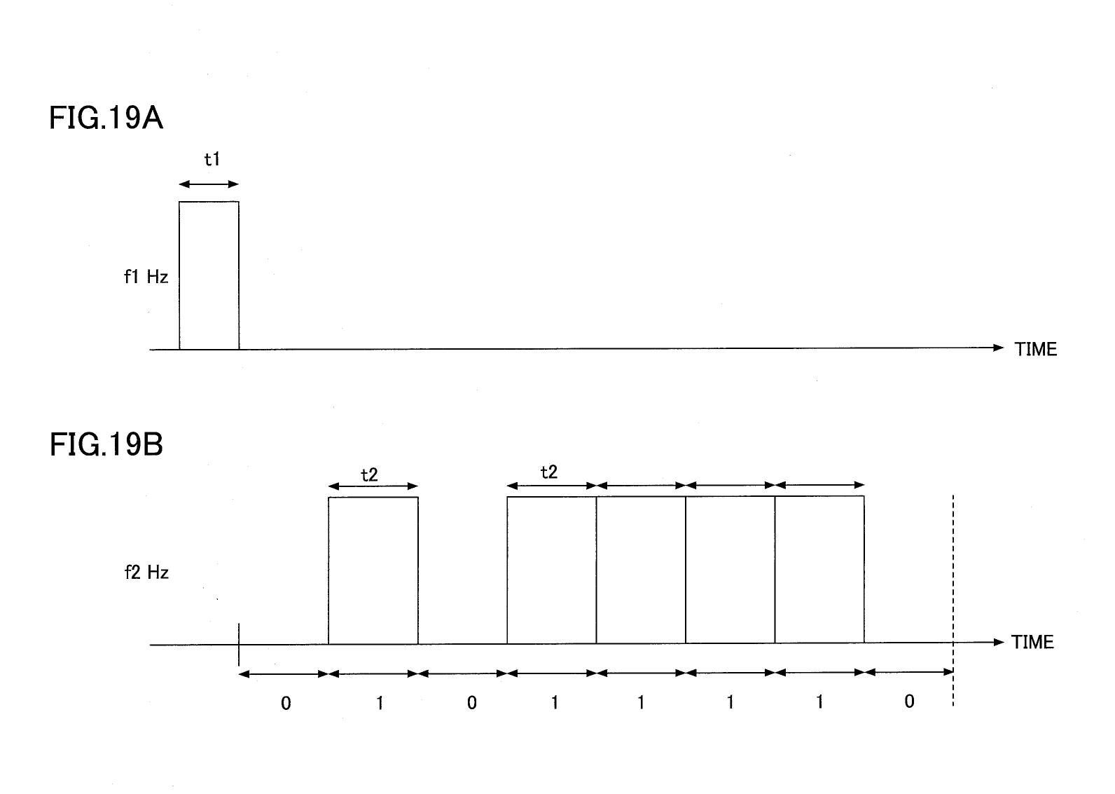

A specific example of generating the above described connection information sound by embedding connection information in sound data is explained. FIG. 19A and FIG. 19B are views illustrating a method of embedding connection information in sound data.

In FIG. 19A and FIG. 19B, a method of embedding connection information in sound data by the sound generation unit 66 of the projector 20 is explained. In FIG. 19A and FIG. 19B, an example that a numeral “94” is embedded in a sound is explained.

FIG. 19A illustrates a state where a sound having a predetermined frequency f1 (Hz) is output for a predetermined period “t1”. In this example, it is assumed that the sound having the predetermined frequency f1 (Hz) output for the predetermined period “t1” indicates a start of numeral information.

FIG. 19B illustrates a state where a sound having a predetermined frequency f2 (Hz) is repeatedly output for a predetermined period “t2” each time. Here, it is assumed that, for example, the sound having the predetermined frequency f2 (Hz) output for the predetermined period “t2” indicates a binary number “1” and no such sound indicates a binary number “0”. Here, the numeral “94” is expressed as a binary number “01011110”.

Thus, the sound generation unit 66 embeds information expressing the binary number “01011110”, which is converted from the numeral “94”, as a sound pattern by combining a period in which the sound having the predetermined frequency f2 (Hz) is output for the predetermined period “t2” and a period in which the sound having the predetermined frequency f2 (Hz) is not output for the predetermined period “t2” as illustrated in FIG. 19B, after the sound having the predetermined frequency f1 (Hz) is output for the predetermined period “t1” as illustrated in FIG. 19A.

Similarly, the sound generation unit 66 may embed an additional binary number expressing the IP address of the projector 20.

When the amount of information embedded in the sound increases, the output period also increases. Thus, the sound generation unit 66 may embed specific codes by which the mobile terminal 10 can recognize a start and an end of the sound, in addition to the starting of the sound, for example. Then, the sound analyzing unit 56 of the mobile terminal 10 can obtain a sound between the start and the end of the sound as the connection information by recognizing the codes expressing the start and the end of the sound. Further, there is a possibility that the receiver cannot accurately obtain the predetermined pattern by the sound due to a noise or the like. Thus, in this embodiment, the above described pattern of sound may be repeatedly output for a plurality of times.

(Method of Extracting Connection Information from Sound Data)

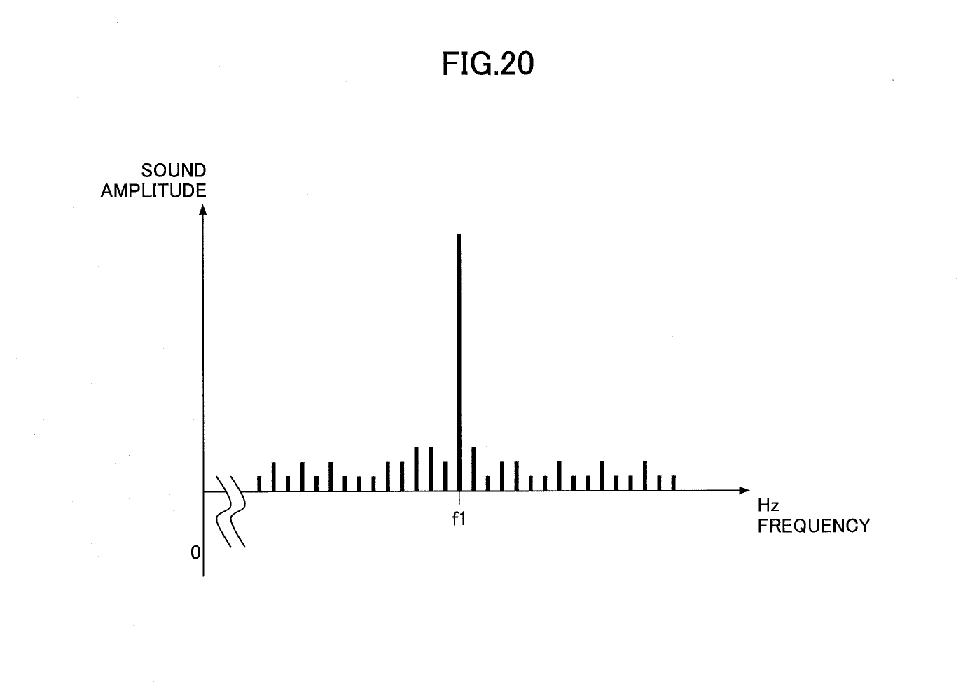

FIG. 20 is a view illustrating a method of extracting the connection information from the sound data. In FIG. 20, a method of extracting the connection information from the sound data by the sound analyzing unit 56 of the mobile terminal 10 is explained. Here, in FIG. 20, the axis of the abscissa indicates a frequency (Hz) and the axis of the ordinate indicates sound amplitude.

When the information is embedded as the sound as explained above with reference to FIG. 19A and FIG. 19B, the sound analyzing unit 56 of the mobile terminal 10 extracts the frequency components by applying the above described FFT on the sound data obtained from the sound collection unit 54 and determines whether the sound having the predetermined frequency f1 (Hz) is included.

It is assumed that a peak appears at the sound having the predetermined frequency f1 (Hz), when the sound having the predetermined frequency f1 (Hz) is included, as shown in FIG. 20. After detecting the sound having the predetermined frequency f1 (Hz), the sound analyzing unit 56 determines whether the sound having the predetermined frequency f2 (Hz) is included. The sound analyzing unit 56 determines that information “1” is included when the sound having the predetermined frequency f2 (Hz) is output for the predetermined period “t2” and information “0” is included when the predetermined frequency f2 (Hz) is not output for the predetermined period “t2”.

The sound analyzing unit 56 converts the binary number “01011110” which is extracted from the pattern of the sound by the above described method, to a decimal number to obtain a numeral “94”. The sound analyzing unit 56 may similarly obtain the numerals for the IP address.

Here, however, there may be a possibility that the embedded information cannot be accurately obtained because of noise or the like when transferring the embedded information.

Thus, the sound control unit 62 of the projector 20 may repeatedly output the same signal of the connection information sound for a predetermined time or a predetermined period. Then, the sound analyzing unit 56 of the mobile terminal 10 may obtain the same signal of the connection information sound output from the projector 20 for a plurality of times and obtain a value by statistically performing the results of the plurality of times of obtaining the signal when analyzing the embedded information. With this configuration, the accuracy in determining the result can be improved.

Further, a generally used error detection code, an error correction code or the like may be used to improve the accuracy of the obtained value.

(Operations of Devices Connected with Each Other Using Connection Information Sound)

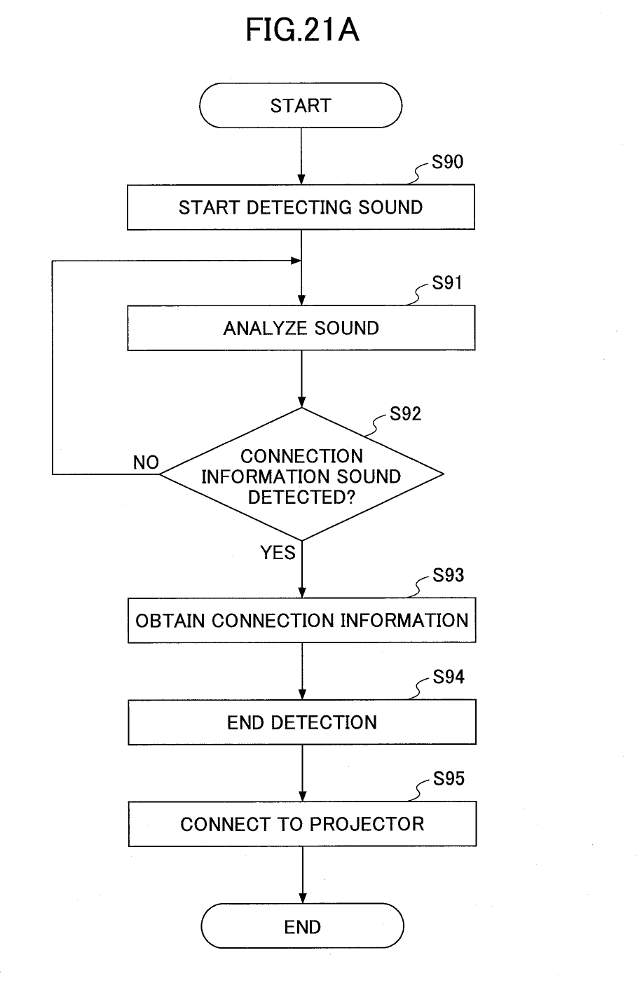

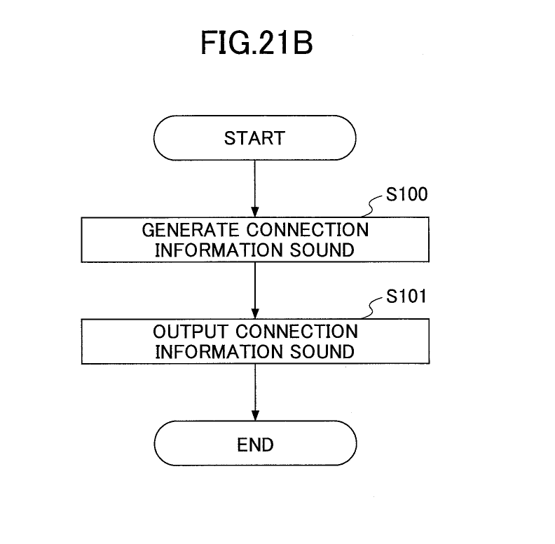

FIG. 21A is a flowchart illustrating an operation of the mobile terminal 10 and FIG. 21B is a flowchart illustrating an operation of the projector 20.

As shown in FIG. 21A, at the mobile terminal 10, the sound collection unit 54 starts collecting (detecting ambient sounds (S90), and the sound analyzing unit 56 analyzes the sounds (S91).

The sound analyzing unit 56 determines whether the connection information sound output from the projector 20 is detected (S92). Then, when it is determined that the connection information sound is detected (YES in S92), the sound analyzing unit 56 obtains connection information included in the connection information sound (S93).

Then, the sound collection unit 54 ends detection of the sound (S94) and the communication unit 42 connects the mobile terminal 10 to the projector 20 via the connection network 2 using the connection information (S95). Then, the process ends. When it is determined that the connection information sound is not detected in S92 (NO in S92), the process of S91 is continued.

As shown in FIG. 21B, at the projector 20, when the sound generation unit 66 generates the connection information sound (S100), the sound output unit 63 outputs the connection information sound (S101). Then, the process ends.

As described above, the projector 20 may start the process by a trigger such as when an input instruction by the user from the input unit 60 is obtained, when activating the system, when responding to the device search from an external device (mobile terminal 10, for example) via the communication 2, when receiving an instruction to output sound from the external device (mobile terminal 10, for example) via the communication network 2, or the like.

(Structure of Device Cooperation System Outputting Connection Information Sound Based on a Sound Request from Mobile Terminal 10)

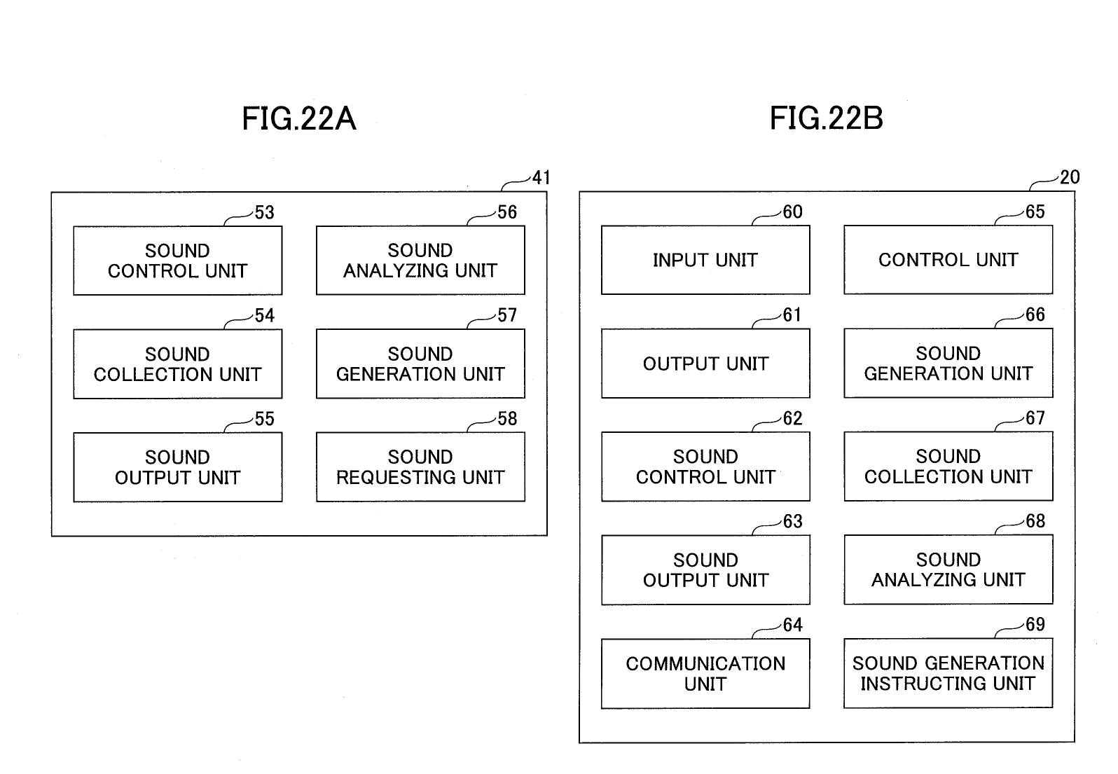

FIG. 22A and FIG. 22B are views illustrating an example of a structure of a device cooperation system using a sound request. FIG. 22A and FIG. 22B illustrate an example in which the mobile terminal 10 outputs a sound request. The “sound request” is a predetermined sound for requesting the external terminal(s) to output their predetermined sound(s). Specifically, when the mobile terminal 10 detects a “shaking” motion as an example of the predetermined motion and the destination is not designated, the mobile terminal 10 outputs a sound request to external devices (the projector 20 is exemplified as an example of the external device) to communicate with for having the external device output the predetermined sound (connection information sound, for example). Then, the external device outputs the predetermined sound in response to the sound request. Then, the mobile terminal 10 communicates with the external device based on the predetermined sound.

FIG. 22A illustrates units included in the data processing unit 41 of the mobile terminal 10, and FIG. 22B illustrates functional blocks of the projector 20.

As shown in FIG. 22A, the data processing unit 41 of the mobile terminal 10 includes the sound control unit 53, the sound collection unit 54, the sound output unit 55, the sound analyzing unit 56, a sound generation unit 57 and a sound requesting unit 58. The data processing unit 41 of mobile terminal 10 illustrated in FIG. 22A includes the sound generation unit 57 and the sound requesting unit 58 in addition to components included in the data processing unit 41 illustrated in FIG. 16. Here, only the different points are explained.

Upon receiving an instruction to search external devices, the projector 20 in this example, by a user via the touch panel display 17, the sound requesting unit 58 instructs the sound control unit 53 to perform processes to generate the sound request (sign sound).

Upon receiving the instruction from the sound requesting unit 58, the sound control unit 53 controls the sound generation unit 57 to generate the sound request and controls the sound output unit 55 to output the sound request generated by the sound generation unit 57 for a predetermined period. Further, the sound control unit 53 controls the sound generation unit 57 to output the sound request again for a predetermined number of times when it is determined that the projector 20 does not output the connection information sound within a predetermined period after the sound request is output from the sound output unit 55 to the projector 20.

Upon receiving the instruction from the sound control unit 53, the sound generation unit 57 generates the sound request. The sound generation unit 57 may generate the sound request with a sound having a frequency bandwidth different from that of the connection information sound output from the projector 20.

As shown in FIG. 22B, the projector 20 includes the input unit 60, the output unit 61, the sound control unit 62, the sound output unit 63, the communication unit 64, the control unit 65, a sound generation unit 66, a sound collection unit 67, a sound analyzing unit 68 and a sound generation instructing unit 69. The projector 20 illustrated in FIG. 22B is different from that illustrated in FIG. 16B that it includes the sound collection unit 67, the sound analyzing unit 68 and the sound generation instructing unit 69. Here, only the different points are explained.

The sound collection unit 67 collects sound data including the sound request from the mobile terminal 10.

When the sound collection unit 67 obtains the sound data, the sound control unit 62 controls the sound analyzing unit 68 to analyze the sound data.

The sound analyzing unit 68 analyzes the sound data obtained from the sound collection unit 67 and detects the sound request from the mobile terminal 10, based on the instruction by the sound control unit 62.

The sound control unit 62 determines whether the sound request from the mobile terminal 10 is detects based on the analysis by the sound analyzing unit 68. When it is determined that the sound request from the mobile terminal 10 is detected, the sound control unit 62 outputs the fact to the sound generation instructing unit 69.

When the sound request from the mobile terminal 10 is detected, the sound generation instructing unit 69 controls the sound control unit 62 to perform processes to output the connection information sound. Here, the sound generation instructing unit 69 may control the sound control unit 62 to perform the processes to output the connection information sound when an instruction by the user is input from the input unit 60, the system is activate, or an existence of the mobile terminal 10 is detected by using infrared ray, supersonic wave, visible light sensor or the like.

Upon receiving the instruction from the sound generation instructing unit 69, the sound control unit 62 controls the sound generation unit 66 to generate the connection information sound. The sound control unit 62 may control the sound generation unit 66 to vary the volume of the connection information sound in accordance with the volume of the sound request obtained from the mobile terminal 10.

With the above configuration, when the mobile terminal 10 outputs the sound request toward the projector 20 and the projector 20 obtains the sound request, the projector 20 outputs the connection information sound. Thus, it is unnecessary for the projector 20 to continuously output the connection information sound so that energy can be saved.

(Operational Sequence of Device Provided with Sound Generation Instructing Unit)

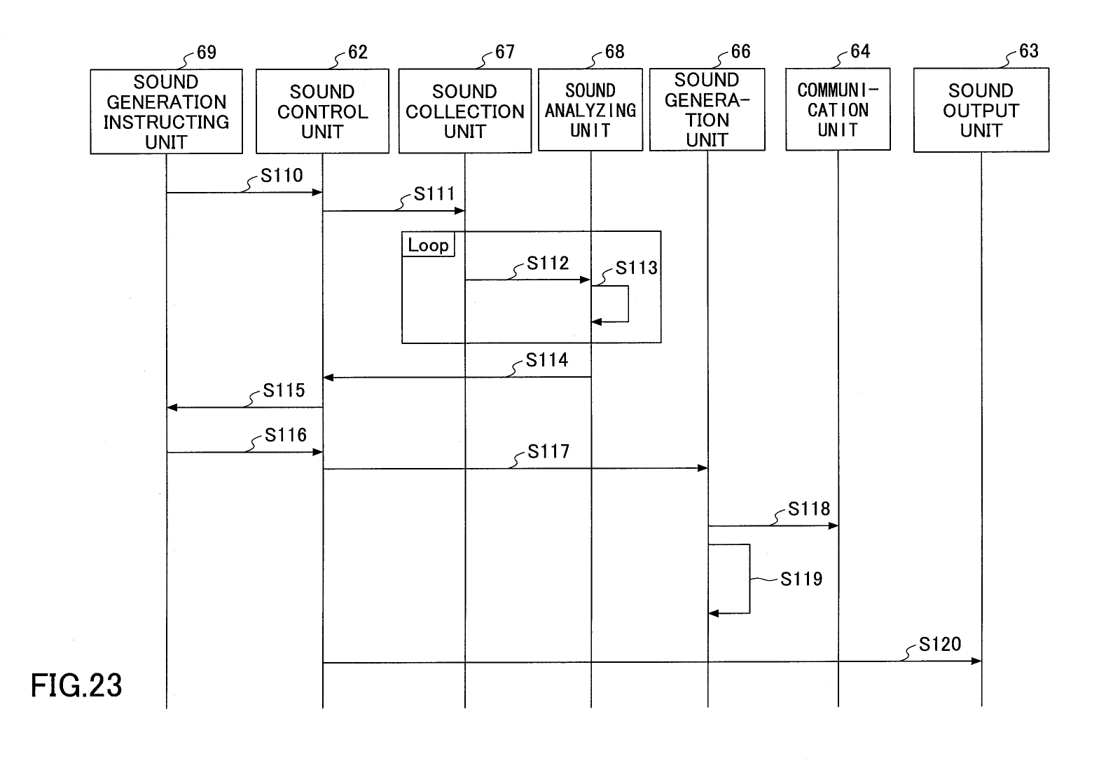

FIG. 23 is a sequence diagram illustrating an example of an operation of the projector 20 provided with the sound generation instructing unit 69. In FIG. 23, the operation of the projector 20 is explained using the sound generation instructing unit 69, the sound control unit 62, the sound collection unit 67, the sound analyzing unit 68, the sound generation unit 66, the communication unit 64 and the sound output unit 63.

Compared with the operation illustrated in FIG. 17, processes to a process in which the projector 20 obtains the sound request output from the mobile terminal 10 based on an instruction from the sound generation instructing unit 69 of the projector 20 are different. Processes of S117 to S120 illustrated in FIG. 23 are the same as the processes S70 to S73 illustrated in FIG. 17 and the explanation to which is not repeated.

As shown in FIG. 23, when the system is activated or the like, the sound generation instructing unit 69 of the projector 20 instructs the sound control unit 62 to collect the sound (S110). Then, the sound control unit 62 outputs an instruction to collect the sound to the sound collection unit 67 (S111).

The sound collection unit 67 converts the collected sound to sound data and outputs it to the sound analyzing unit 68 (S112). The sound analyzing unit 68 analyzes the sound data obtained from the sound collection unit 67 (S113). Upon receiving the sound request from the mobile terminal 10, the sound analyzing unit 68 outputs the fact to the sound control unit 62 (S114). Then, the sound control unit 62 outputs the fact to the sound generation instructing unit 69 (S115).

Upon receiving the fact that the sound request is obtained, the sound generation instructing unit 69 submits to the sound control unit 62 to generate the information sound (S116). The process of S112 by the sound collection unit 67 and the process of S113 by the sound analyzing unit 68 are looped until the sound analyzing unit 68 obtains the sound request from the mobile terminal 10.

(Operational Sequence of Mobile Terminal Provided with Sound Requesting Unit)

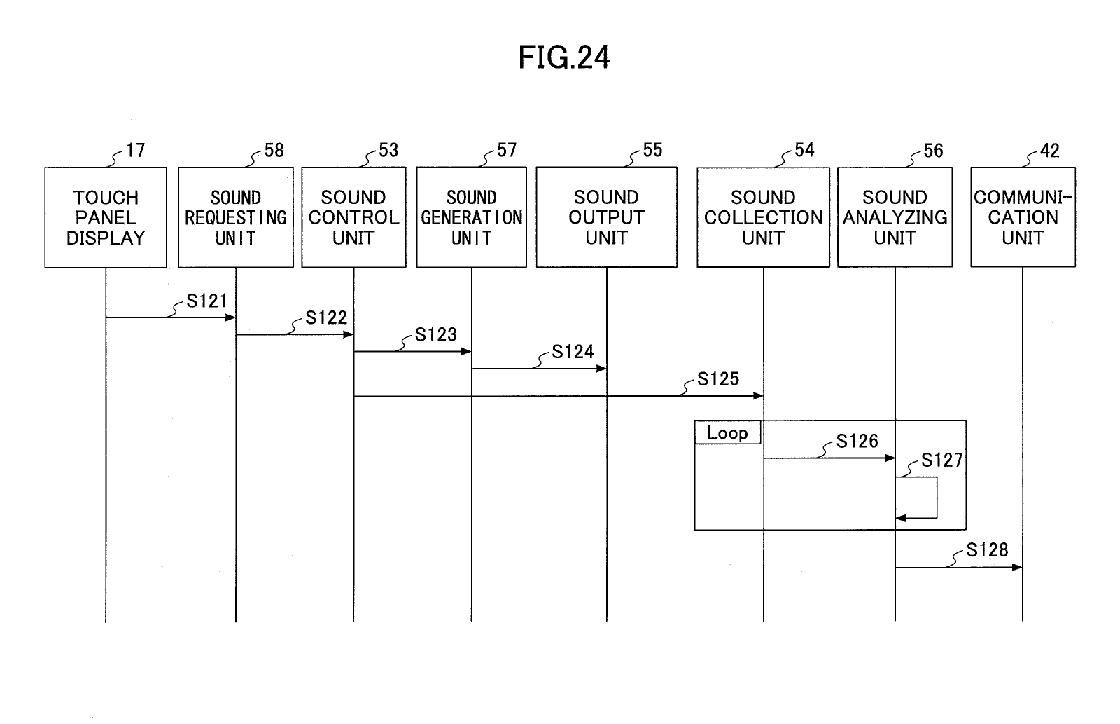

FIG. 24 is a sequence diagram illustrating an example of an operation of the mobile terminal 10 provided with the sound requesting unit 58. In FIG. 24, the operation of the mobile terminal 10 is explained using the touch panel display 17, the sound requesting unit 58, the sound control unit 53, the sound generation unit 57, the sound output unit 55, the sound collection unit 54, the sound analyzing unit 56 and the communication unit 42.

Compared with the operation illustrated in FIG. 18, processes to a process in which the mobile terminal 10 outputs the sound request for the projector 20 to output the connection information sound are different. Processes of S125 to S128 illustrated in FIG. 18 are the same as the processes S81 to S84 illustrated in FIG. 18 and the explanation to which is not repeated.

For example, when a user inputs an instruction to start searching external devices, including the projector 20, to the touch panel display 17 of the mobile terminal 10, the touch panel display 17 outputs a signal indicating to generate a sound request to the sound requesting unit 58 (S121). Then, the sound requesting unit 58 instructs the sound control unit 53 to perform processes to generate the sound request (S122).

Then, the sound control unit 53 controls the sound generation unit 57 to generate the sound request (S123), the sound generation unit 57 generates the sound request (S124), and the sound output unit 55 outputs the sound request.

(Operation of Mobile Terminal Provided with Sound Requesting Unit)

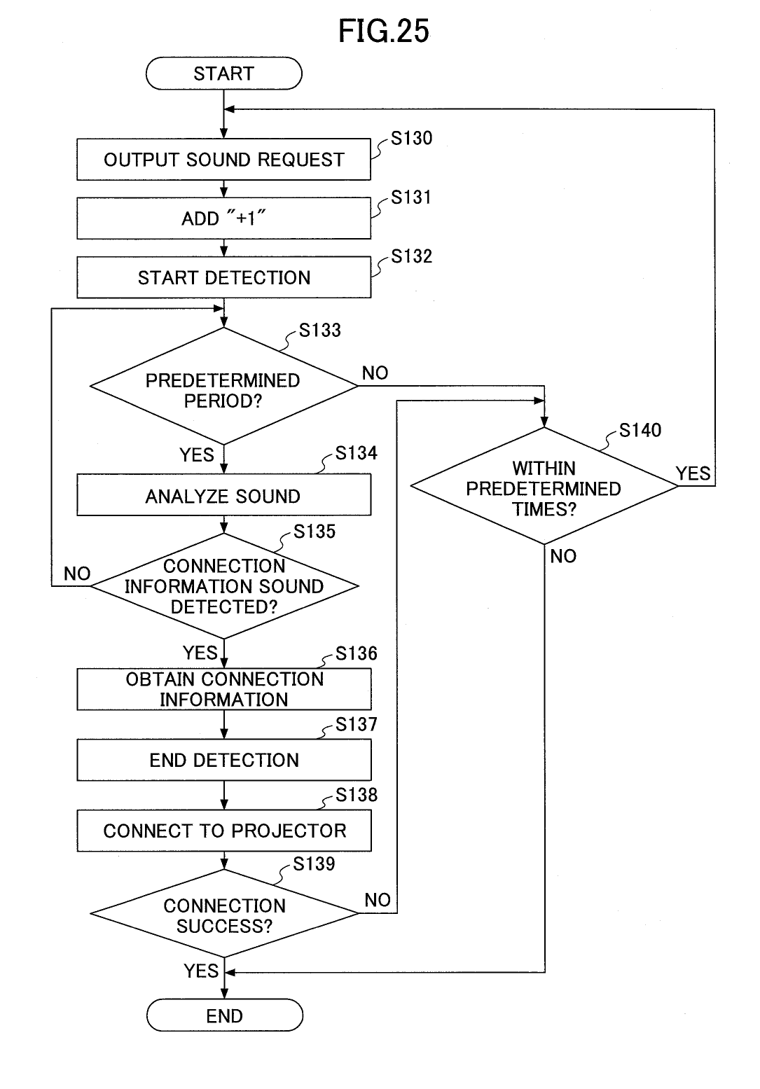

FIG. 25 is a flowchart illustrating an operation of the mobile terminal 10 provided with the sound requesting unit 58. In FIG. 25, an example is illustrated in which the mobile terminal 10 outputs the sound request again when the projector 20 cannot obtain the sound request once output from the mobile terminal 10 due to a temporal noise or the like and the projector 20 does not output the connection information sound. With this configuration, a failure in obtaining the sound request by the projector 20 can be recovered.

Specifically, as shown in FIG. 25, in the mobile terminal 10, when the sound output unit 55 outputs the sound request generated by the sound generation unit 57 based on the request by the sound requesting unit 58 (S130), the sound control unit 53 adds “+1” to the number of times the sound request is output (S131).

Then, the sound collection unit 54 starts detecting the connection information sound output from the projector 20 (S132). Meanwhile, the sound control unit 53 determines whether it is within a predetermined period after the sound request is output in S130 (S133).

When it is determined that it is within the predetermined time after the sound request is output (YES in S133), the sound control unit 53 controls the sound analyzing unit 56 to analyze the sound data (S134) and determines whether the connection information sound is detected (S135).

When it is determined that it is not within the predetermined period after the sound request is output (NO in S133), the sound control unit 53 determines whether the number of outputs of the sound request is within predetermined number of times (S140). When the sound control unit 53 determines that the number of outputs of the sound request is within the predetermined number of times (YES in S140) the process returns to S130. When the sound control unit 53 determines that the number of outputs of the sound request is not within the predetermined number of times (NO in S140), the process ends.

When the sound control unit 53 determines that the connection information sound is not detected based on the analysis by the sound analyzing unit 56 (NO in S135), the process of S133 is continued. On the other hand, when the sound control unit 53 determines that the connection information sound is detected based on the analysis by the sound analyzing unit 56 (YES in S135), the sound control unit 53 obtains the connection information included in the connection information sound (S136).

Then, the sound collection unit 54 ends the process of collecting sounds (S137) and the communication unit 42 connects the mobile terminal 10 to the projector 20 via the communication network 2 using the connection information (S138).

The communication unit 42 determines whether the connection between the projector 20 is successfully established (S139), and ends the process when it is determined that the connection is successfully established (YES in S139). When the communication unit 42 determines that the connection is not successfully established (NO in S139), the process returns to S140.

As described above, the sound control unit 53 of the mobile terminal 10 counts the number of outputs of the sound request and controls the sound generation unit 57 to output the sound request for the predetermined number of times when it is determined that the connection information sound is not output from the projector 20 within the predetermined number of times after the sound request is output.

Here, when the sound control unit 53 determines that the number of outputs of the sound request exceeds the predetermined number of times in S140, the sound control unit 53 may repeat the processes from S130 after adjusting and increasing the volume of the sound request. Further, the sound control unit 53 may adjust the volume of the sound request in accordance with noises collected by the sound collection unit 54, a distance to the projector 20, or the like and control to output the sound request again.

Similarly, the sound control unit 69 of the projector 20 may control to adjust the volume of the connection information sound when the connection from the mobile terminal 10 is not established within a predetermined period after the sound request from the mobile terminal 10 is obtained and output the connection information sound again. With this configuration, failures of the mobile terminal 10 to obtain the connection information sound or establish connection can be recovered.

(Operation of Device Provided with Sound Generation Instructing Unit)

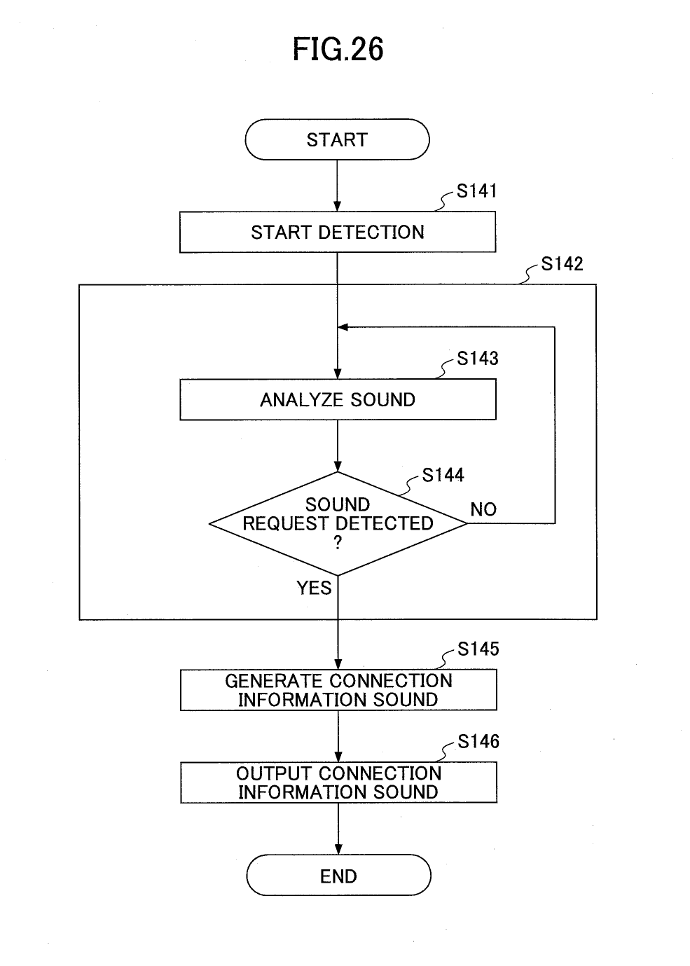

FIG. 26 is a flowchart illustrating an operation of the projector 20 provided with the sound generation instructing unit 69. As shown in FIG. 26, in the projector 20, when the system is activated or the like, the sound collection unit 67 starts collecting ambient sounds upon receiving an instruction from the sound generation instructing unit 69 (S141), and starts a sub process (S142).

In the sub process of S142, the sound control unit 62 controls the sound analyzing unit 68 to analyze the collected sound (S143), and determines whether the sound request is detected (S144). When the sound control unit 62 determines that the sound request is not detected (NO in S144), the process returns to S143.

When the sound control unit 62 determines that the sound request is detected (YES in S144), the sound generation unit 66 generates the connection information sound (S145) and the sound output unit 63 outputs the connection information sound (S146). Then, the process ends.

In the sub process of S142, the projector 20 may repeatedly collect the ambient sound for a case in which the sound request is output from a plurality of the mobile terminals 10.

### (Example of Output Timing of Connection Information Sound)

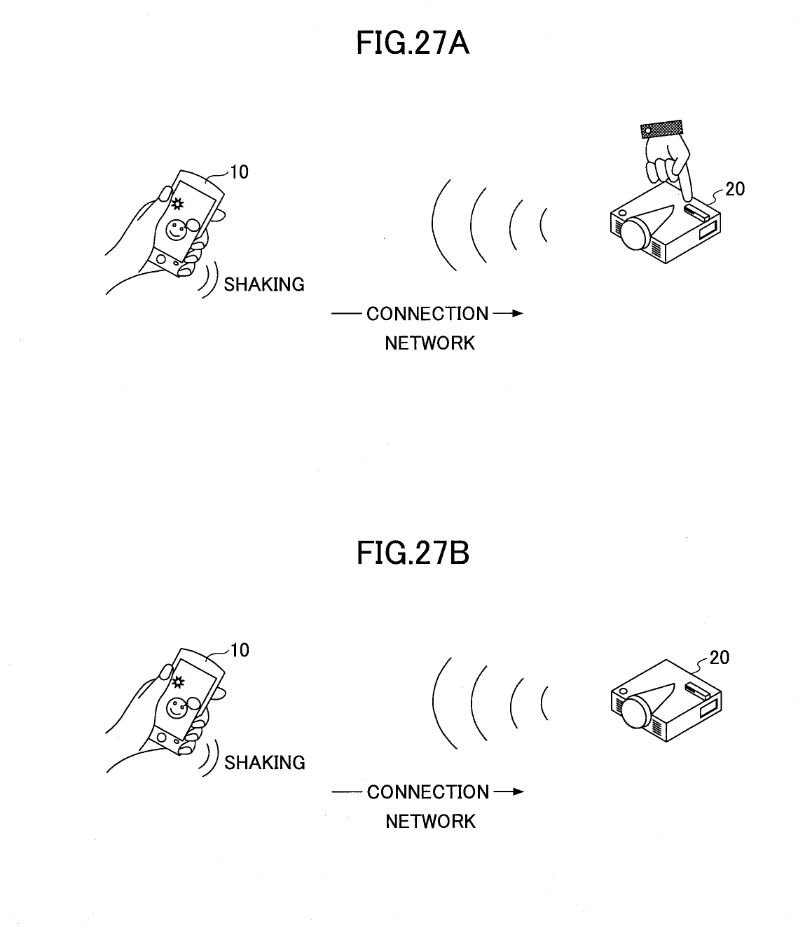

FIG. 27A and FIG. 27B are views for explaining timing at which the connection information sound is output. In FIG. 27A and FIG. 27B, timing of outputting the connection information sound based on an instruction by the sound generation instructing unit 69 is explained. Here, when the mobile terminal 10 detects the “shaking” motion of the mobile terminal 10 as an example of the predetermined motion and the destination is not designated, the mobile terminal 10 tries to connect with an external device (in this case, the projector 20 is exemplified) using the connection information sound.

FIG. 27A illustrates an example in which the connection information sound is output when an instruction by a user is input to the input unit 60 of the projector 20. For the example illustrated in FIG. 27A, for example, when the sound generation instructing unit 69 of the projector 20 detects an input instruction by the user via the input unit 60 before a process of S70 in FIG. 17, the sound generation instructing unit 69 submits to the sound control unit 62 to perform the processes to generate the connection information sound.

FIG. 27B illustrates an example in which the connection information sound is continuously output from the projector 20 while the system is being operated (activated). For the example illustrated in FIG. 27B, when the sound generation instructing unit 69 of the projector 20 detects the activation of the system, the sound generation instructing unit 69 submits to the sound control unit 62 to perform the process to generate the connection information sound.

### (When Another Unit is Provided)

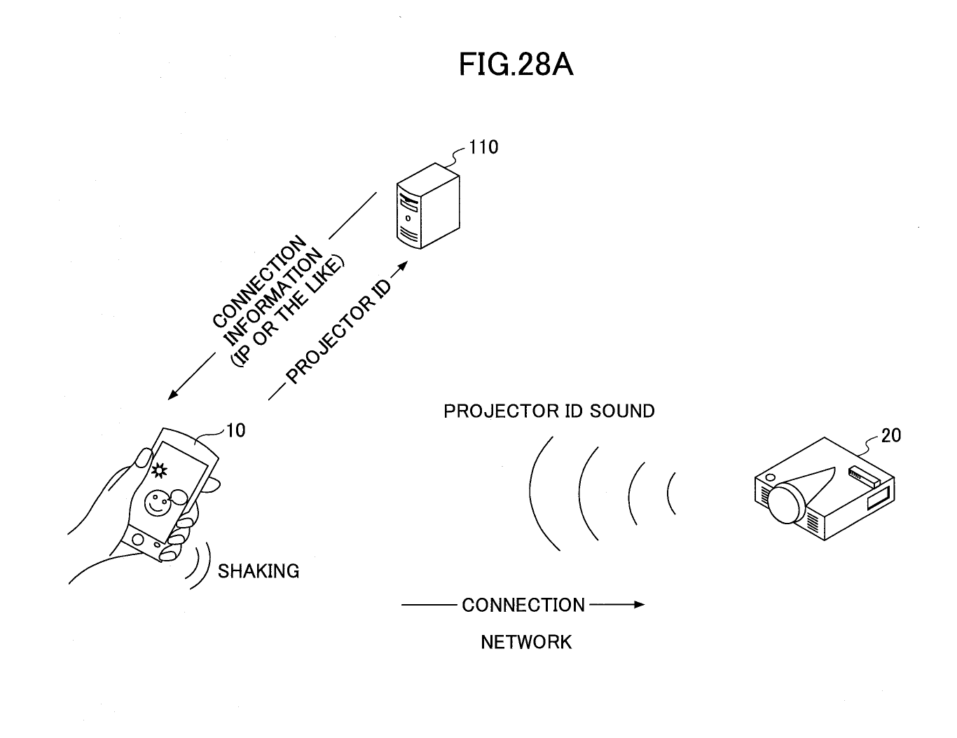

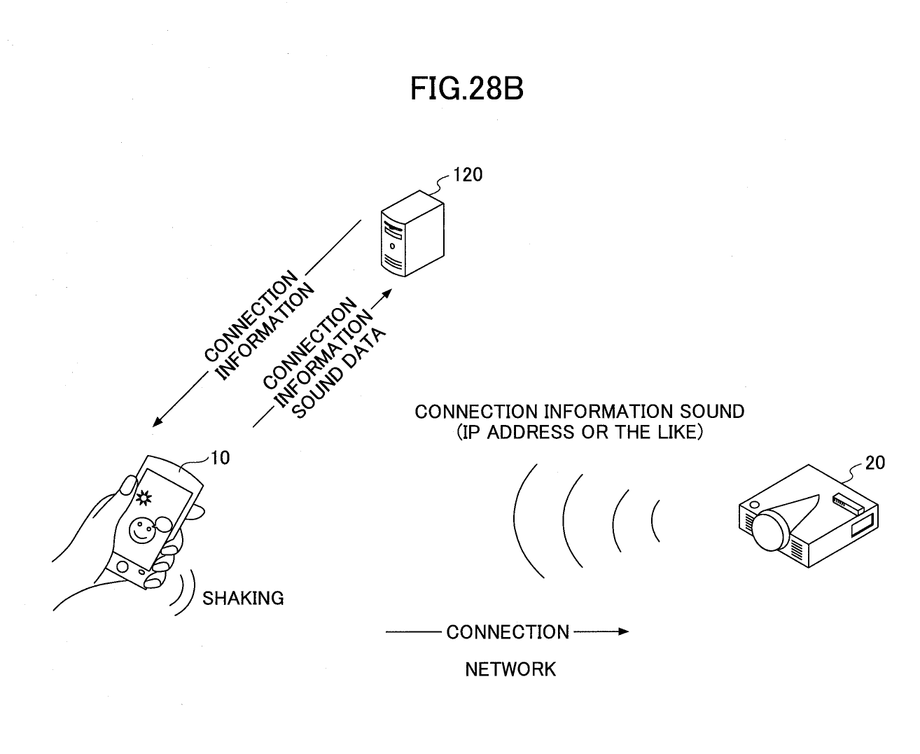

FIG. 28A and FIG. 28B are views illustrating an example in which another unit is further provided in the device cooperation system. FIG. 28A illustrates an example in which a connection information converting unit 110 is provided in the device cooperation system 1 as additional structure.

As described above, the mobile terminal 10 connects to the projector 20 by obtaining the connection information such as an IP address or the like included in the connection information sound output from the projector 20.

On the other hand, for the example illustrated in FIG. 28A, identification data (projector ID) unique to the projector 20 and the connection information (an IP address or the like) for connecting to the projector 20 are previously stored in the connection information converting unit 110 in a corresponding manner. The projector ID unique to the projector 20 may be a two-digit numeral or the like capable of uniquely identifying the projector 20.

As shown in FIG. 28A, when the projector 20 outputs the identification data sound (projector ID sound) in which the unique projector ID is embedded, the sound collection unit 54 of the mobile terminal 10 obtains the projector ID sound and the sound analyzing unit 56 analyzes the projector ID sound to obtain the projector ID unique to the projector 20.

Then, the communication unit 42 of the mobile terminal 10 sends the obtained projector ID to the connection information converting unit 110 via the communication network 2 or the like and receives the connection information of the projector 20 corresponding to the projector ID from the connection information converting unit 110. The communication unit 42 of the mobile terminal 10 connects the mobile terminal 10 to the projector 20 via the communication network 2 using the obtained connection information.

With this configuration, by using the projector ID, the data amount of which is less than that of the connection information such as an IP address or the like, a period necessary for analyzing the sound by the mobile terminal 10 can be reduced and the accuracy can be increased.

FIG. 28B illustrates an example in which a sound analyzing unit 120 is provided in the device cooperation system 1 as an additional structure.

As described above, the mobile terminal 10 connects to the projector 20 by having the sound analyzing unit 56 analyze the connection information sound output from the projector 20 to obtain the connection information.

On the other hand, for the example illustrated in FIG. 28B, the sound collection unit 54 of the mobile terminal 10 collects the connection information sound output from the projector 20. Further, the communication unit 42 of the mobile terminal 10 sends the collected connection information sound data to the sound analyzing unit 120 via the communication network 2 or the like.

Here, the sound analyzing unit 120 has the same function as the sound analyzing unit 56. The sound analyzing unit 120 analyzes the connection information sound data received by the mobile terminal 10 to extract the connection information and send to the mobile terminal 10. The communication unit 42 of the mobile terminal 10 receives the connection information of the projector 20 from the sound analyzing unit 120. Then, the communication unit 42 of the mobile terminal 10 is capable of connecting the mobile terminal 10 to the projector 20 via the communication network 2 using the connection information.

The connection information converting unit 110 and the sound analyzing unit 120 may be composed of a data processing apparatus such as a server apparatus, a client apparatus or the like, and may be composed of a cloud server or the like provided at a different place, for example.

As described above, according to the embodiment, it is possible for a mobile terminal to connect with an external device with a simple operation. Although in this embodiment, the projection device such as a projector or the image forming apparatus such as a MFP or the like is exemplified as a device to perform a device cooperation process between the mobile terminal, it is not limited so. The external device to perform the device cooperation process between the mobile terminal may be another mobile terminal, a data processing apparatus such as a Personal Computer (PC) or the like, a television or other devices.

In this embodiment, although an example in which the mobile terminal and the external device are connected by a trigger that the “shaking” motion of the mobile terminal by the user is performed is exemplified, it is not limited so. For example, the trigger may be a sliding motion of the finger of the user to the touch panel display of the mobile terminal. At this time, it may be assumed that the user slides the finger toward a direction at which the external device that the user wishes to use is positioned. With this configuration, the mobile terminal can be connected to the external device by an intuitive operation of the user.

In this embodiment, it is possible to recognize whether the external device to be connected is a projector or an image forming apparatus based on the difference in the “shaking” motion of the mobile terminal (whether the mobile terminal is shaken leftward and rightward, or upward and downward) as described above. However, when the mobile terminal includes a voice recognition function, the kind of external device may be recognized using the voice recognition.

For example, the user may speak the kind of the external device to be connected (the “projector” or the “printer”, for example) to the mobile terminal and shake the mobile terminal. Then, the voice recognition function of the mobile terminal may analyze the voice of the user to determine the kind of the external device. With this configuration, the mobile terminal can be connected to the determined kind of the external device.

For example, when a plurality of external devices respond to a search request, the mobile terminal can perform the process to connect to the external devices of the desired kind based on the device information obtained by the response.

The mobile terminal may perform a conversion process to a data format in accordance with the kind of the external device. Specifically, the mobile terminal may convert the data to print data when the external device to be connected is an image forming apparatus and convert the data to projection data when the external device to be connected is a projector. Then, the mobile terminal may send the converted data to the external device to be connected.

According to the embodiment, a device cooperation apparatus and a device cooperation method capable of being easily connected to an external device to perform a device cooperation process by a simple operation are provided.

Although a preferred embodiment of the data processing apparatus (device cooperation apparatus) and the device cooperation method has been specifically illustrated and described, it is to be understood that minor modifications may be made therein without departing from the spirit and scope of the invention as defined by the claims.

The individual constituents of the device cooperation system 1 may be embodied by arbitrary combinations of hardware and software, typified by a CPU of an arbitrary computer, a memory, a program loaded in the memory so as to embody the constituents illustrated in the drawings, a storage unit for storing the program such as a hard disk, and an interface for network connection. It may be understood by those skilled in the art that methods and devices for the embodiment allow various modifications.

The present invention is not limited to the specifically disclosed embodiments, and numerous variations and modifications may be made without departing from the spirit and scope of the present invention.

The present application is based on and claims the benefit of priority of Japanese Priority Application No. 2012-192669 filed on Aug. 31, 2012, the entire contents of which are hereby incorporated by reference.

What is claimed is:

1. A data processing apparatus, comprising:
a motion determining unit that detects a predetermined motion of a mobile terminal; and
a data processing unit that selects a device to perform a device cooperation process with and to communicate with the mobile terminal based on a predetermined sound output by one or more devices, which are positioned nearby the mobile terminal, when the motion determining unit detects the predetermined motion of the mobile terminal, the predetermined sound being different for each of the devices.

2. The data processing apparatus according to claim 1, further comprising:
an identification data sending unit that sends identification data identifying one or more devices that are candidates to perform the device cooperation process with and to communicate with, to the devices, respectively, and
wherein the data processing unit selects the device to perform the device cooperation process with and to communicate with the mobile terminal among the devices that receive the identification data.

3. The data processing apparatus according to claim 2, wherein the identification data sending unit sends sound data including a predetermined pattern corresponding to the respective device to each of the devices, as the identification data.

4. The data processing apparatus according to claim 3, wherein the identification data sending unit sends the sound data in a form of an animation file to each of the devices.

5. The data processing apparatus according to claim 1, wherein the data processing unit selects the device based on connection information sound including information specifying an address of the device output by the device as the predetermined sound.

6. The data processing apparatus according to claim 2, further comprising:
a destination determining unit that determines whether the device to perform the device cooperation process with and to communicate with is designated, and
wherein the identification data sending unit sends the identification data to the devices, respectively, when it is determined by the destination determining unit that the device to perform the device cooperation process with and to communicate with.

7. The data processing apparatus according to claim 6, wherein the data processing unit selects a device designated as a destination when it is determined by the destination determining unit that the device to communicate with is designated.

8. The data processing apparatus according to claim 1, wherein the data processing unit controls to send predetermined test data to the device selected to perform the device cooperation process with and to communicate with the mobile terminal when starting a communication with the device.

9. The data processing apparatus according to claim 1,
wherein the data processing apparatus is the mobile terminal,
the data processing apparatus further including a communication unit that communicates with the device selected by the data processing unit.

10. A device cooperation method performed by a data processing apparatus, comprising:
a motion detection step of detecting a predetermined motion of a mobile terminal; and
a device selection step of selecting a device to perform a device cooperation process with and to communicate with the mobile terminal based on a predetermined sound output by one or more devices, which are positioned nearby the mobile terminal, when the predetermined motion of the mobile terminal is detected in the motion detection step, the predetermined sound being different for each of the devices.

11. The device cooperation method according to claim 10, further comprising:
an identification data sending step of sending identification data identifying one or more devices that are candidates to perform the device cooperation process with and to communicate with, to the devices, respectively, and
wherein in the device selection step, the device to perform the device cooperation process with and to communicate with the mobile terminal is selected among the devices that receive the identification data.

12. The device cooperation method according to claim 11, wherein in the identification data sending step, sound data including a predetermined pattern corresponding to the respective device is sent to each of the devices, as the identification data.

13. The device cooperation method according to claim 12, wherein in the identification data sending step, the sound data in a form of an animation file is sent to each of the devices.

14. The device cooperation method according to claim 10, wherein in the device selection step, the device is selected based on connection information sound including information specifying an address of the device output by the device as the predetermined sound.

15. The device cooperation method according to claim 11, further comprising:
a destination determining step of determining whether the device to perform the device cooperation process with and to communicate with is designated, and
wherein in the identification data sending step, the identification data are sent to the devices, respectively, when it is determined in the destination determining step that the device to perform the device cooperation process with and to communicate with.

16. The device cooperation method according to claim 15, wherein in the device selection step, a device designated as a destination is selected when it is determined in the destination determining step that the device to communicate with is designated.

17. The device cooperation method according to claim 10, wherein the device selection step includes controlling to send predetermined test data to the device selected to perform the device cooperation process with and to communicate with the mobile terminal when starting a communication with the device.

18. The device cooperation method according to claim 10,
wherein the data processing apparatus is the mobile terminal,
the method further including a communication step of communicating with the device selected in the device selection step.

19. A non-transitory computer-readable recording medium having recorded thereon a program that causes a computer to execute a device cooperation method comprising:
a motion detection step of detecting a predetermined motion of a mobile terminal; and
a device selection step of selecting a device to perform a device cooperation process with and to communicate with the mobile terminal based on a predetermined sound output by one or more devices, which are positioned nearby the mobile terminal, when the predetermined motion of the mobile terminal is detected in the motion detection step, the predetermined sound being different for each of the devices.

20. The non-transitory computer-readable recording medium according to claim 19,
wherein the data processing apparatus is the mobile terminal,
the method further including a communication step of communicating with the device selected in the device selection step.
